(19) United States
(12) Patent Application Publication
(10) Pub. No.: US 2006/0233266 A1
(43) Pub. Date: Oct. 19, 2006

(54) Content processing device, content transmitting device, content receiving device, content distribution system, content synchronization program, and recording medium

(75) Inventor: Junji Suetsugu, Tenri-shi (JP)

Correspondence Address: BIRCH STEWART KOLASCH & BIRCH, PO BOX 747, FALLS CHURCH, VA, 22040-0747, US

(73) Assignee: Sharp Kabushiki Kaisha

(21) Appl. No.: 11/366,568

(22) Filed: Mar. 3, 2006

(30) Foreign Application Priority Data
Mar. 4, 2005 (JP) 2005-060920

(51) Int. Cl. H04L 27/00

(52) U.S. Cl. 375/259

(57) ABSTRACT

On a transmission-side, a time information generating section generates transmission-side time information based on information about a characteristic point in a waveform of an AC voltage supplied from an AC power supply. The content processing section adds the transmission-side time information to predetermined content. The communicating section transmits, to another communicating section on a receiving end, the “content in association with the transmission-side time information”. On the receiving-side, a time information generating section generates reception-side time information based on information about the characteristic point in the waveform of the AC voltage supplied from the AC power supply. A content processing section processes content, in sync with the transmission-side, based on a correlation between (i) the reception-side time information generated by the time information generating section on the receiving-side, and (ii) the transmission-side time information which is in association with the received content.

This Nonprovisional application claims priority under 35 U.S.C. § 119(a) on Patent Application No. 2005/060920 filed in Japan on Mar. 4, 2005, the entire contents of which are hereby incorporated by reference.

### FIELD OF THE INVENTION

The present invention relates to a content processing device, a content transmitting device, a content receiving device, a content distribution system, a content-synchronization program, each of which being for processing content while being synchronized with one another. The present invention also relates to a computer-readable recording medium storing therein the content-synchronization program.

### BACKGROUND OF THE INVENTION

As a new broadcasting service, terrestrial digitalbroadcasting service has been collecting attentions in recent years. This service transmits a high-quality image for a home-use device (e.g. a TV set or a video deck) by using MPEG2TS (Moving Picture Experts Group 2 over IP Transfer System). Further, the service streams an image for a mobile device such as a mobile phone by using MPEG4 method.

MPEG2TS is a push-type communication. That is, in communication, a data transmitting device plays the leading role for transmitting data, and a data receiving device receives and processes the data in accordance with the data transmitting device. In a case where delay in data transmission which occurs along the transmission path varies, the variation in the delay of the data transmission is eliminated by providing a data buffer for temporarily storing data received by the data receiving device. In this method, however, it is necessary to prevent an underrun error or an overrun error of the data buffer, in a case of streaming data by using MPEG2TS which is the push type communication.

Here concerned are drift and jitter of the local clock which is provided to the data transmitting device and the data receiving device. Clock drift is a deviation from an absolute time, which is attributed to a lot-to-lot variation occurring in the production stage of the device, and the amount of the deviation is quantitative. For example, if the drift causes a clock to fall behind the absolute time by 2 sec. per month, the clock will fall behind the absolute time by 6 sec. after three months. Meanwhile, clock jitter is a variation in an amount of drift, the variation being caused by a change in an environment such as the temperature. The clock jitter is variable error. As described, in the local clock provided to the data transmitting device and the data receiving device, the deviation from the absolute time is always varying in accordance with the environment surrounding the device.

That is, the absolute time of the local clock in the data transmitting device and the absolute time of the local clock in the data receiving device do not coincide with each other, unless something is done besides merely using the local clock of each device. As a result, it is not able to synchronize processing of data in the both devices, which may consequently cause an underrun or overrun error in the data buffer. For example, a Japanese Unexamined Patent Publication No. 180255/2004 (Tokukai 2004-180255) discloses a technology which solves the jitter or the drift in the local clock of the data transmitting device and the local clock of the data receiving device.

The publication discloses a technology for synchronizing (i) a frequency of a clock signal of a client device with (ii) a frequency of a clock signal of a server device, by using a power source synchronized-pulse which is synchronized with a power source frequency of the electric power to be inputted.

However, in the network system disclosed in the publication, the clock of the client device is synchronized with the clock of the server device. Accordingly, the client device needs to be synchronized with the server device, every time the server device to be synchronized with the client device is switched to another server device.

For instance, while a user is watching a program on a TV, the user may frequently change the channel during a TV commercial, by using a remote control. At this point, if the user changes a channel of a BS broadcast to a channel of the terrestrial digital broadcasting, a tuner for providing content data (video data) to the TV is switched from a BS tuner to a terrestrial digital tuner. In this case, in the network system of the foregoing publication, the TV is synchronized with the server device. Therefore, while the content data is being played, the image may be deteriorated and/or the sound may be disrupted, until the TV and the server device are synchronized with each other.

Further, in recent years, a video deck have a function called time shift function. This function allows the following. Namely, while the video deck is recording a program being on air on a recording medium, a user is able to view the program being recorded from the beginning. While the user is viewing a program by using this function, if the user catches up the program being on air by skipping the commercial messages, fast forwarding, or the like, the TV needs to switch the video being played, from the video having been recorded by the video deck to the video being on air, which is being provided from the tuner. At this point, the source which distributes the video data to the TV is switched from the video deck to the tuner. Accordingly, the if the TV is to be synchronized with the server devices, the same problem occurs as in the case of changing the channel during the viewing of a program being on air.

The present invention is made in view of the foregoing problems, and it is an object of the present invention to provide a content processing device which is capable of continuously synchronizing processing of content, even if a device to be synchronized is switched to another device.

### SUMMARY OF THE INVENTION

An object of the present invention is to provide a content processing device which is capable of continuously synchronizing processing of content, even if a device to be synchronized is switched to another device.

In order to achieve the foregoing object, a content processing device of the present invention is a content processing device for performing content process, the content processing device sharing an AC power supply with another device, comprising: characteristic point detecting means for (i) detecting a characteristic point in a waveform of the AC power supply, and (ii) generating characteristic point information which is information about the characteristic point detected; time information generating means for generating, based on the characteristic point information, own time information of the content processing device, the own time information being to be referred in the content process of the content processing device's own or in content process of the another device; transmitting means for transmitting, to the another device, given content and the own time information generated by time information generating means, the content and the own time information being transmitted in association with each other; receiving means for receiving, from the another device with which the content processing device shares the AC power supply, given content and time information of the another device, the content and the time information of the another device being in association with each other; and content processing means for processing the received content, based on a correlation between (i) the time information, which is in association with the received content, of the another device, and (ii) the own time information which is generated by the time information generating means.

In the configuration, the characteristic point detecting means in the content processing device detects the characteristic point in the waveform of the AC power supply (e.g. in the waveform of an AC voltage from the AC power supply). Then, the characteristic point detecting means generates the characteristic point information of the characteristic point detected. For example, the characteristic point detected by the characteristic point detecting means is a point (e.g. a zero-crossing point or a peak) which periodically occurs in the waveform of the AC power supply. The characteristic point detecting means generates the characteristic point information indicating that the characteristic point is detected. Further, based on the characteristic point information generated, the time information generating means generates the own time information. At this point, the time information generating means generates, based on the characteristic point information which is periodically generated, the own time information which indicates a time interval at which the characteristic point information is generated.

Here, in the content processing device, the transmitting means transmits, to the another device, the own time information generated and the content in association with each other. For example, the transmitting means adds the own time information to the content, and transmits them to another content processing device with which the content processing device shares the same AC power supply. When the content processing device receives the content, the receiving means receives content and time information transmitted from the another content processing device.

Then, the content processing means in the content processing device processes the received content. At this point, the content processing means processes the received content, based on a correlation between: (i) the time information generated in the another content processing device, the time information which is in association with the received content, and (ii) the own time information generated. Here, the content processing device transmitting the content and the another content processing device receiving and processing the received content both detect characteristic point in the waveform of the common AC power supply. Then, the both content processing devices generate the time information based on the information about the characteristic point having been detected. Typically, a characteristic (frequency, amplitude, etc.) of the waveform of the AC power supply is adjusted in an extremely rigorous manner. Accordingly, it is guaranteed that the time information generated based on the waveform of the common AC power supply is generated at the same time interval in both of the content processing devices. In other words, the time information generated in the content processing device on the content transmission side, and the time information generated in the content processing device on the content reception side are updated at the same interval.

Thus, for example, the content processing means adjusts its own time information to the received time information, so as to adjust its timing for processing the content. Then, the content processing means processes the content, based on the correlation between both pieces of the time information. Accordingly, the content processing means is able to process the content in sync with the other content processing device transmitting the content. Here, even if the content processing device on the content transmission side is replaced with another content processing device, the another content processing device, which has been newly provided, also generates time information based on information about the characteristic point in the waveform of the common AC power supply. Accordingly, in the new transmission side content processing device, the time information will still be generated at the same timing as the timing at which the time information is generated in the reception side content processing device. Accordingly, even if the transmission side content processing device is replaced with another content processing device, the reception side content processing device is able to keep processing the content in sync with the transmission side content processing device, without a need of carrying out a process for synchronizing these content processing devices.

In order to achieve the foregoing object, a content processing device of the present invention is a content processing device, comprising: reference signal information receiving means for receiving reference signal information from a reference signal information transmitting device; time information generating means for generating own time information based on the reference signal information having been received; transmitting means for transmitting, to another device, content and the own time information generated by time information generating means, the content and the time information being transmitted in association with each other; content receiving means for receiving, from the another content processing device, content and time information of the another content processing device, the content and the time information of the another content processing device being in association with each other; and content processing means for processing the content received from the another content processing device, based on a correlation between (i) the time information, which is associated with the received content, of the another content processing device and (ii) the own time information generated by the time information generating means, the reference signal information transmitting device carrying out (a) a process of detecting a characteristic point in a waveform of an AC power supply, and generating characteristic point information about the detected characteristic point, (b) a process of generating time information based on the characteristic point information, and (c) a process of generating, based on the time information generated by the reference signal information transmitting device, the reference signal information which is for use in correcting the own time information.

In the configuration, reference signal information transmitting means detects the characteristic point in the waveform of the AC power supply, and generates the characteristic point information of the characteristic point detected. Then, the reference signal information transmitting means generates, based on the characteristic point information, the time information of the reference signal transmitting means. Based on the time information of the reference signal information transmitting means, the reference signal information for correcting time information of another device is generated and is transmitted from the reference signal transmitting means. In the content processing device, the reference signal information receiving means receives the reference signal information transmitted from the reference signal information transmitting means. Then, own time information is generated in the content processing device, based on the reference signal information. Further, in the content processing device, the transmitting means transmits, to another content processing device, the own time information and the given content in association with each other. The content receiving means receives content and time information from another device.

Then, the content processing means processes the received content based on the correlation between (i) the time information of the another device, which is in association with the received content, and (ii) the own time information generated by the time information generating means. Here, both pieces of the time information are generated based on the received reference signal information having been received by the respective reference signal information receiving means. This reference signal information is generated in the reference signal information transmitting means, based on the time information generated based on the information about the characteristic point in the waveform of the AC power supply. In short, both pieces of the time information derive from the information about the characteristic point in the waveform of the common AC power supply. Typically, a characteristic (frequency, amplitude, etc.) of the waveform of the AC power supply is adjusted in an extremely rigorous manner. Accordingly, it is guaranteed that the time information generated based on the waveform of the common AC power supply is generated at the same time interval in both of the content processing devices. In other words, the time information generated in the content processing device on the content transmission side, and the time information generated in the content processing device on the content reception side are updated at the same interval.

Accordingly, the content processing device of the present invention is able to process content in sync with another content processing device. Further, even if the content processing device of the present invention does not share the AC power supply with the another content processing device, the content processing device of the present invention is able to process the content in sync with the another content processing device.

In order to achieve the foregoing object, a content transmitting device of the present invention is a content transmitting device for transmitting content to a content receiving device, the content transmitting device sharing an AC power supply with the content receiving device, comprising: characteristic point detecting means for (i) detecting a characteristic point in a waveform of the AC power supply, and (ii) generating characteristic point information which is information about the characteristic point detected; time information generating means for generating, based on the characteristic point information, transmission-side time information which is to be referred in the content process of the content transmitting device's own or in content process of the content receiving device; and transmitting means for transmitting, to the content receiving device, given content and the transmission-side time information, the content and the transmission-side time information being transmitted in association with each other.

In the configuration, the characteristic point detecting means detects the characteristic point in the waveform of the AC power supply (e.g. in the waveform of an AC voltage from the AC power supply). Then, the characteristic point detecting means generates the characteristic point information of the characteristic point detected. Further, the time information generating means generates, based on the characteristic point information generated, the transmission-side time information which is to be referred in the processing of the content. Further, the transmitting means transmitting means transmits, to the content receiving device, given content and the transmission-side time information in association with each other. This content receiving device shares the common AC supply with the content transmitting device.

In the configuration, the characteristic point detecting means in the content processing device detects the characteristic point in the waveform of the AC power supply. Then, the characteristic point detecting means generates the characteristic point information of the characteristic point detected. For example, the characteristic point detected by the characteristic point detecting means is a point (e.g. a zero-crossing point or a peak) which periodically occurs in the waveform of the AC power supply. The characteristic point detecting means generates the characteristic point information indicating that the characteristic point is detected. Further, the time information generating means generates the transmission-side time information based on the generated characteristic point information. At this point, the time information generating means generates, based on the characteristic point information which is periodically generated, the transmission-side time information which indicates a time interval at which the characteristic point information is generated.

Further, the transmitting means transmitting means transmits, to the content receiving device, given content and the transmission-side time information in association with each other. Typically, a characteristic (frequency, amplitude, etc.) of the waveform of the AC power supply is adjusted with rigorous accuracy. Accordingly, it is guaranteed that the transmission-side time information generated based on the information about the characteristic point in the waveform of the common AC power supply is generated at more accurate timing than a local clock or the like. As described, the content transmitting device is able to supply to the content receiving device, information needed for the content receiving device to more accurately process the content in sync with the content transmitting device.

In order to achieve the foregoing object, a content receiving device of the present invention is a content receiving device for processing content transmitted from a content transmitting device, the content receiving device sharing an AC power supply with the content transmitting device, comprising: characteristic point detecting means for (i) detecting a characteristic point in a waveform of the AC power supply, and (ii) generating characteristic point information which is information about the characteristic point detected; time information generating means for generating, based on the characteristic point information, reception-side time information which is to be referred in the content process of the content receiving device's own; receiving means for receiving, from the content transmitting device, the content and transmission-side time information, the content and the time information of the another device being in association with each other; and content processing means for processing the received content, based on a correlation between (i) the transmission-side time information which is in association with the received content and (ii) the reception-side time information generated by the time information generating means.

In the configuration, the characteristic point detecting means in the content receiving device detects the characteristic point in the waveform of the AC power supply (e.g. in the waveform of an AC voltage from the AC power supply). Then, the characteristic point detecting means generates the characteristic point information of the characteristic point detected. For example, the characteristic point detected by the characteristic point detecting means is a point (e.g. a zero-crossing point or a peak) which periodically occurs in the waveform of the AC power supply. The characteristic point detecting means generates the characteristic point information indicating that the characteristic point is detected. Further, based on the characteristic point information generated, the time information generating means generates the reception-side time information. At this point, the time information generating means generates, based on the characteristic point information which is periodically generated, the reception-side time information which indicates a time interval at which the characteristic point information is generated.

Here, in the content receiving device, receiving means receives, from the content transmitting device, the content and transmission-side time information. Further, the content processing means processes the received content. At this point, the content processing means processes the content based on the correlation between (i) the transmission-side time information which is in association with the received content and (ii) the reception-side time information generated by the time information generating means. Here, it is assumed that the content transmitting device transmitting the content and the content receiving device receiving and processing the received content both detect characteristic point in the waveform of the common AC power supply. Further, it is assumed that the both of the devices generate the time information based on the information about the characteristic point having been detected. Typically, a characteristic (frequency, amplitude, etc.) of the waveform of the AC power supply is adjusted in an extremely rigorous manner. Accordingly, it is guaranteed that the transmission-side time information and the transmission-side time information generated based on the waveform of the common AC power supply are generated at the same timing. In other words, the transmission-side time information in the content transmitting device, and the reception-side time information in the content receiving device are both updated at the same interval. Thus, for example, the content processing means adjusts the reception-side time information to the received reception-side time information, so as to adjust its timing for processing the content. Then, the content processing means processes the content, based on the correlation between the transmission-side time information and the reception-side time information. Thus, the content processing means is able to process the received content, in sync with the content transmitting device which (i) generates the transmission-side time information based on the waveform of the common AC power supply, and (ii) transmits the transmission-side time information along with the content. Here, even if the content transmitting device is replaced with another content transmitting device, the another content transmitting device, which has been newly provided, also generates time information based on information about the characteristic point in the waveform of the common AC power supply. Accordingly, in the new content transmitting device, the transmission-side time information will still be generated at the same timing as the timing at which the reception-side time information is generated in the content receiving device. Accordingly, even if the content transmitting device is replaced with another content transmitting device, the content receiving device is able to keep processing the content in sync with the another content transmitting device, without a need of carrying out a process for synchronizing these devices.

Additional objects, features, and strengths of the present invention will be made clear by the description below. Further, the advantages of the present invention will be evident from the following explanation in reference to the drawings.

### BRIEF DESCRIPTION OF THE DRAWINGS

FIG. 1 is a block diagram illustrating exemplary configurations of a content transmitting device and a content receiving device of Embodiment 1, in accordance with the present invention.

FIG. 2 is a block diagram illustrating an example of an overall configuration of a 5.1-channel surround sound system of Embodiment 1, in accordance with the present invention, the 5.1-channel surround system adopting a processing synchronizing technology of the present invention.

FIG. 3 is a block diagram illustrating a configuration of a content distribution system of Embodiment 1, in accordance with the present invention.

FIG. 4 is a block diagram illustrating a configuration of a content distribution system of Embodiment 2, in accordance with the present invention.

FIG. 5 is a block diagram illustrating exemplary configurations of a content transmitting device and a content receiving device of Embodiment 2, in accordance with the present invention.

FIG. 6 is a flowchart illustrating a procedure in which the content transmitting device of Embodiment 2 transmits, to the content receiving device, “content in association with the transmission-side time information”.

FIG. 7 is a flowchart illustrating a procedure in which (i) the content receiving device of Embodiment 2 receives the “content in association with the transmission-side time information” from the content transmitting device in the content distribution system, and (ii) the content receiving device processes the “content in association with the transmission-side time information”.

FIG. 8 is a block diagram illustrating a configuration of a content distribution system of Embodiment 3, in accordance with the present invention.

FIG. 9 is a block diagram illustrating an exemplary configuration of a reference signal information transmitting device of Embodiment 3.

FIG. 10 is a flowchart illustrating a procedure in which the reference signal information transmitting device of Embodiment 3 transmits, as the reference signal information, a control signal such as a beacon to other devices in the content distribution system.

FIG. 11 is a flowchart illustrating a procedure in which the reference signal information transmitting device of Embodiment 3 transmits, to the other device in the content distribution system, a data frame or a control frame as the reference signal information, the data frame or the control frame including time information.

FIG. 12 is a block diagram illustrating a configuration of a content distribution system of Embodiment 4, in accordance with the present invention.

FIG. 13 is a block diagram illustrating an exemplary configuration of a content processing device of Embodiment 4, in accordance with the present invention.

FIG. 14 is a flowchart illustrating a procedure in which (i) the content processing device of Embodiment 4 receives the reference signal information transmitted from a content transmitting device in the content distribution system, and (ii) the content processing device corrects, based on the received reference signal information, reception-side time information which is under the control of the content processing device.

FIG. 15 is a block diagram illustrating a configuration of a content distribution system of Embodiment 5, in accordance with the present invention.

FIG. 16 is a block diagram illustrating an exemplary configuration of a content receiving device of Embodiment 5, in accordance with the present invention.

FIG. 17 is a flowchart illustrating a procedure in which (i) the content receiving device of Embodiment 5 receives the reference signal information from the content transmitting device in the content distribution system, and (ii) the content receiving device corrects, based on the received reference signal information, the reception-side time information which is under the control of the content receiving device.

FIG. 18 is a diagram illustrating exemplary exterior appearances of the devices of Embodiments 1 through 5, in accordance with the present invention.

FIG. 19 is a block diagram illustrating an exemplary configuration of each of the devices of Embodiments 1 through 5, in accordance with the present invention.

### DESCRIPTION OF THE EMBODIMENTS

### EMBODIMENT 1

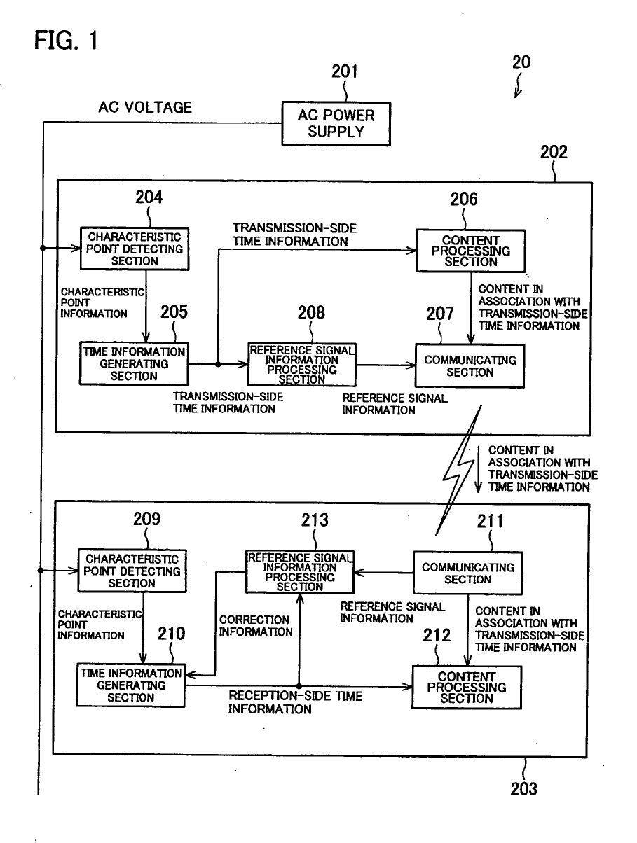

The following describes Embodiment 1 in accordance with the present invention, with reference to FIG. 1 to FIG. 3.

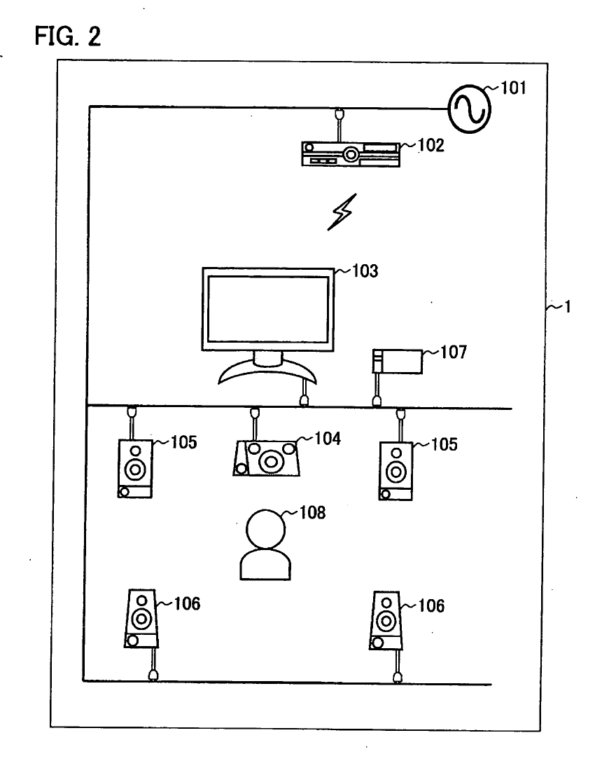

First described with reference to FIG. 2 is an overview of a surround sound system 1 of Embodiment 1. FIG. 2 is a diagram providing an overall view of an exemplary configuration of a 5.1-channel surround sound system 1 which utilizes a processing synchronizing technology of the present invention. As illustrated in the figure, the surround sound system 1 includes: an AC power supply 101; a video server 102; a TV set 103; a center speaker 104; front speakers 105; rear speakers 106; and a sub woofer 107.

By using the surround sound system 1, a user 108 views a video displayed on the TV set 103, and listens to a sound produced by the center speaker 104 or the like.

The AC power supply 101 supplies a common AC voltage to each device such as the video server 102 in the surround sound system 1. Thus the devices of the system share thereamong the same AC power supply 101. As described later, the AC power supply 101 provides time information which serves as reference while the devices of the surround sound system 1 are processing content in synch with each other.

Note that the AC power supply 101 is not particularly limited as long as the AC power supply 101 is a general home-use power supply which supplies, to various home-use devices, the power supplied from an electric power company. For example, the AC power supply 101 may be a power supply which supplies, to each device of the surround sound system 1, an AC voltage of 50 or 60 hertz in frequency.

The video server 102 records content such as a video and/or a piece of music on: (i) an internal recording medium such as a hard disk provided to the video server 102; or (ii) an external recording medium such as DVD, into which data is written by using a DVD drive provided in the video server 102. Further, the video server 103 reads out content such as a video or a piece of music from the internal recording medium or the external recording medium. Then, the video server 103 processes the content based on a characteristic of a waveform of the AC voltage supplied from the AC power supply 101, and then output the processed content to the TV set 103 or the speakers 104 to 107.

The TV set 103 plays video content or the like inputted from the video server 102. Further, while the TV set 103 is playing the video content or the like, the TV set 103 synchronizes the content processing with the speakers 104 to 107 based on the characteristic of the waveform of the AC voltage supplied from the AC power supply 101.

The speakers 104 to 107 are: (i) the center speaker 104 which is located in front of the user 108, for producing sound travelling towards the user 108; (ii) the front speakers 105 which are located on the left and right of the viewpoint of the user 108, for producing sound travelling towards the right and left side of the user 108; (iii) the rear speakers 106 which are located on the back-left and back right of the user 108, for producing sound traveling towards the left and the right of the back of the user 108; and (iv) a sub woofer 107 which produces a vigorous low sound. These speakers play audio content which is inputted from the video server 102 to the TV set 103. Further, while the audio content is played, the speakers are synchronized with each other or with the TV set 103, based on the waveform of the AC voltage supplied from the AC power supply 101.

The following describes an example where the content distribution system 20 is a 5.1-channel surround sound system which adopts a processing synchronizing technology of the present invention.

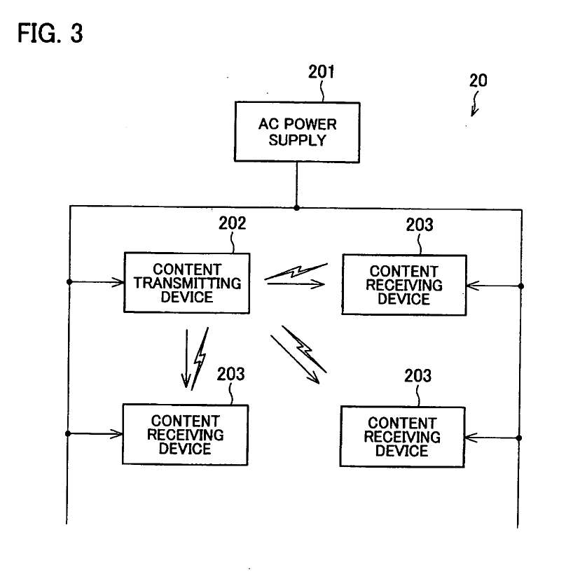

First described with reference to FIG. 3 is an overview of content distribution system 20 of Embodiment 1 in accordance with the present invention. FIG. 3 is a block diagram illustrating a configuration of the content distribution system 20 of Embodiment 1. As illustrated in the figure, the content distribution system 20 includes: an AC power supply 201; a content transmitting device 202; and three content receiving devices 203. From the same AC power supply 201, a common AC voltage is supplied to the content transmitting device 202 and the content receiving devices 203. The content transmitting device 202 and the content receiving devices 203 process content, in sync with one another based on the AC voltage.

The following describes, with reference to FIG. 1, the content transmitting device 202, and the content receiving devices 203 of Embodiment 1 in accordance with the present invention.

FIG. 1 is a block diagram illustrating exemplary configurations of the content transmitting device 202 and one of the content receiving devices 203. More specifically, the figure illustrates an operation for a high-quality play back of content in the 5.1-channel surround sound system 1 which adopts the process synchronizing technology of Embodiment 1.

As illustrated in FIG. 1, the content distribution system 20 includes: the AC power supply 201; the content transmitting device 202 such as the video server 102; and the content receiving device 203 such as a TV set or a speaker. Here, the content transmitting device 202 includes: a characteristic point detecting section 204; a time information generating section 205; a content processing section 206; a communicating section 207; and a reference signal information processing section 208. On the other hand, the content receiving device 203 includes: a characteristic point detecting section 209; a time information generating section 210; a communicating section 211; a content processing section 212; and a reference signal information processing section 213.

The AC power supply 201 is similar to the foregoing AC power supply 101, and the explanation therefor is omitted here.

The characteristic point detecting section 204 in the content transmitting device 202 generates characteristic point information, based on the waveform of the AC voltage supplied from the AC power supply 201 to the content transmitting device 202, and outputs the characteristic point information to the time information generating section 205. Then, the time information generating section 205 generates time information based on the inputted characteristic point information. The operations of the characteristic point detecting section 209 and the time information generating section 210 in the content receiving device 203 are the same as those of the characteristic point detecting section 204 and the time information generating section 205.

A common AC voltage is supplied from the AC power supply 201 to the content transmitting device 202 and the content receiving device 203. As a result, transmission-side time information generated by the time information generating section 205 in the content transmitting device 202 and the reception-side time information generated by the time information generating section 210 in the content receiving device 203 have an exactly identical progression. The time information generating section 205 outputs, to the content processing section 206 in the content transmitting device 202, the transmission-side time information whose progression is identical to that of the reception-side time information. The content processing section 206 adds, to the content to be transmitted to the content receiving device 203, the transmission-side time information having been inputted, and outputs them to the communicating section 207. The communicating section 207 transmits the “content in association with the transmission-side time information”.

On the other hand, in the content receiving device 203, the communicating section 211 receives the “content in association with the transmission-side time information”, which has been transmitted from the content transmitting device 202. Then, the communicating section 211 outputs, to the content processing section 212, the received “content in association with the transmission-side time information”. The content processing section 212 confirms a correlation between (i) the transmission-side time information added to the inputted content and (ii) the reception-side time information generated by the time information generating section 210 in the content receiving device 203. More specifically, the content processing section 212 processes the content based on the correlation between the two pieces of the time information. Thus, while the content is playing, the content receiving device 203 is able to prevent transmission jitter which occurs along the communication path. In short, the content receiving device 203 is able to process the content, in sync with the content transmitting device 202.

Further, the time information generating section 205 in the content transmitting device 202 outputs the transmission-side time information to the reference signal information processing section 208. The reference signal information processing section 208 generates reference signal information based on the inputted transmission-side time information, and outputs the reference signal information to the communicating section 207. The communicating section 207 transmits the inputted reference signal information to the content receiving device 203.

On the other hand, in the content receiving device 203, the communicating section 211 receives the reference signal information, and outputs the reference signal information to the reference signal information processing section 213. The reference signal information processing section 213 compares (i) the reception-side time information inputted from the time information generating section 210 with (ii) the transmission-side time information in the reference signal information, so as to generate a correction information. Then, the reference signal information processing section 213 outputs the generated correction information to the time information generating section 210. Based on this correction information inputted, the time information generating section 210 corrects the reception-side time information which is under the control of the time information generating section 210. Thus, it is possible to solve an offset between (i) the transmission-side time information generated in the content transmitting device 202 and (ii) the reception-side time information generated in the content receiving device 203. As a result, the content transmitting device 202 and the content receiving device 203 are able to process the content, in sync with each other. That is, for example, it is possible to restrain a variation in the delay which occurs along the transmission path, the variation causing quality deterioration of the content.

Further, at this point, the plurality of the content receiving devices 203 in the content distribution system 20 correct their respective pieces of the reception-side time information based on the identical reference signal information. Accordingly, each of the content receiving devices 203 is able to process the content in sync with the content transmitting device 202, at the exactly same timing. That is, in each of the content receiving devices 203, the content is processed at the same pace. Thus, in a case where the content receiving devices 203 are different speakers for respectively producing sounds of different channels, there will be no sound which is out of sync with the rest of sounds.

The details of the above described synchronized processing of the content is described in the following embodiments.

### EMBODIMENT 2

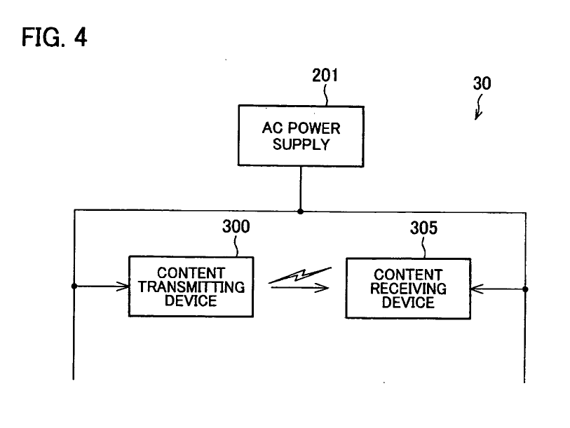

The following describes, with reference to FIG. 4 to FIG. 7, Embodiment 2 of the present invention.

First described with reference to FIG. 4 is an overview of a content distribution system 30 of Embodiment 2 in accordance with the present invention. The following description deals with an example where content is transmitted between the video server 102 and the TV set 103 illustrated in FIG. 2.

FIG. 4 is a block diagram illustrating a configuration of the content distribution system 30 of Embodiment 2 in accordance with the present invention. As illustrated, the content distribution system 30 includes: an AC power supply 201; a content transmitting device 300; and a content receiving device 305. From the same AC power supply 201, a common AC voltage is supplied to the content transmitting device 300 and the content receiving device 305. Based on the AC voltage, the content transmitting device 300 and the content receiving device 305 process the content, in sync with each other.

Note that, in the present embodiment, the content transmitting device 300 corresponds to the video server 102, and the content receiving device 305 corresponds to the TV set 103. That is, the content transmitting device 300 is a device which distributes the content to the content receiving device 305. Further, the content receiving device 305 is a device which receives and processes the content having been distributed from the content transmitting device 300. Here, the wording “processing the content” means to execute at least one of the following three processes: i.e., (i) a process for playing the distributed content; (ii) a process for recording the content; or (iii) a process for editing the content.

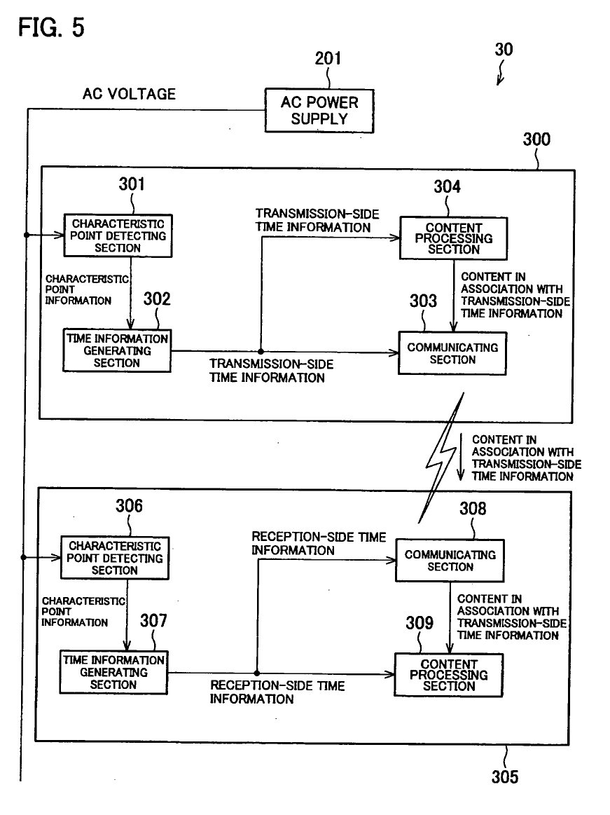

The following describes, with reference to FIG. 5, the content transmitting device 300 and the content receiving device 305 of Embodiment 2 in accordance with the present invention.

FIG. 5 is a block diagram illustrating exemplary configurations of the content transmitting device 300 and the content receiving device 305 of Embodiment 2. As illustrated in the figure, the content transmitting device 300 includes: a characteristic point detecting section 301; a time information generating section 302; a communicating section 303; and a content processing section 304.

From the AC power supply 201, an AC voltage which is to be supplied to the content transmitting device 300 is inputted to the characteristic point detecting section 301. The characteristic point detecting section. 301 detects a characteristic point based on the waveform of the AC voltage having been inputted. Further, the characteristic point detecting section 301 outputs information indicating the detected characteristic point to the time information generating section 302. Note that the characteristic point of the AC voltage waveform may be, for example: (i) a zero-crossing point where the AC voltage is 0V; (ii) a peak point at which the AC voltage is the maximum value; or (iii) noise from another electric device, such as a microwave oven, being mixed into the AC voltage.

The time information generating section 302 generates transmission-side time information, based on the characteristic point information inputted from the characteristic point detecting section 301. At this point, the transmission-side time information generated by the time information generating section 302 may be information about a time interval. For example, if the characteristic point information is inputted from the characteristic point detecting section 301 at an interval of 10 ms, information indicating the 10 ms is generated as the transmission-side time information. Alternatively, the content transmitting device 300 may count how many times the characteristic point information has been inputted, so as to measure how much time has elapsed since the start of the transmission of the content. Then, information indicating thus measured length of time may be generated as the transmission-side time information. Note that what kind of the transmission-side time information the time information generating section 302 generates may be determined in advance, in the content transmitting device 300. In other words, the time information generating section 302 may generate the transmission-side time information, in accordance with the predetermined conditions.

The time information generating section 302 outputs the generated transmission-side time information to the communicating section 303 and the content processing section 304. This transmission-side time information is always renewed to a new value based on a local clock provided in the time information generating section 302. Accordingly, the time information generating section 302 uses the characteristic point information inputted from the characteristic point detecting section 301 for the purpose of correcting small errors in the local clock of the time information generating section 302.

The communicating section 303 adds the transmission-side time information, which is inputted from the time information generating section 302, to the content which is inputted from the content processing section 304, and which is to be transmitted to the content receiving device 305 in the content distribution system 30.

The content processing section 304 outputs, to the communicating section 303, the content to be transmitted to the content receiving device 305.

On the other hand, the content receiving device 305 includes: a characteristic point detecting section 306; a time information generating section 307; a content processing section 309; and a communicating section 308. The characteristic point detecting section 306 operates identically to the foregoing characteristic point detecting section 301, and therefore its explanation is omitted here. Further, the time information generating section 307 operates identically to the foregoing time information generating section 302, and therefore its explanation is omitted here. The time information generating section 307 outputs, as the reception-side time information, the time information generated therein to the content processing section 309 and the communicating section 308.

The communicating section 308 receives the “content in association with the transmission-side time information” from the content transmitting device 300, and then outputs the “content in association with the transmission-side time information” to the content processing section 309. The content processing section 309 extracts the transmission-side time information from the “content in association with the transmission-side time information” inputted from the communicating section 308, and processes the content by referring to the correlation between the reception-side time information inputted from the time information generating section 307 and the transmission-side time information.

Here, the “correlation” between the transmission-side time information and the reception-side time information is a rule established in the relationship between the two pieces of time information. For example, such a rule may be: a rule that the two pieces of the time information exactly coincide with each other; a rule that an offset between the two pieces of the time information is constant; or a rule that the offset between the two pieces of the time information changes at a constant ratio, with the elapse of time. Further, the wording “processing the content” means to execute at least one of the following three processes: i.e., (i) a process for playing the content; (ii) a process for recording the content; or (iii) a process for editing the content. For example, the processing of the content may be (i) a process of playing content such as a movie or a piece of music, by using a TV set and/or a speaker, at a time being determined by a content distributor; or (ii) a process of recording the content on a recording medium.

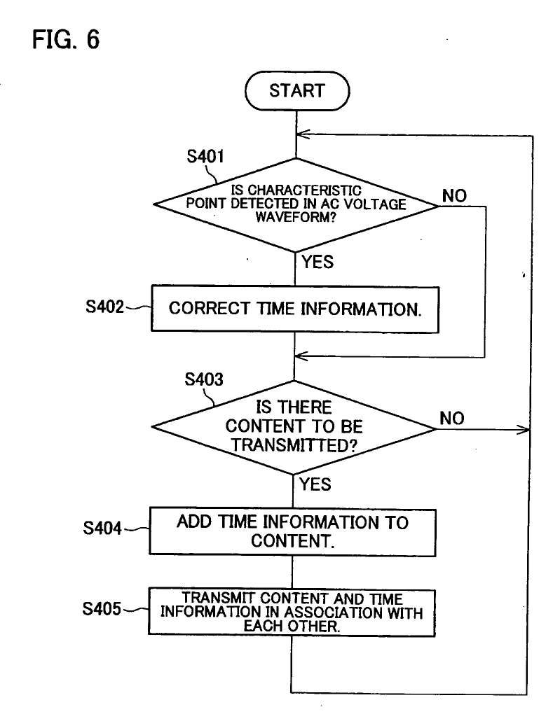

Next described with reference to FIG. 6 is a procedure in which the content transmitting device 300 transmits, to the content receiving device 305, the “content in association with the transmission-side time information”.

FIG. 6 is a flowchart illustrating the procedure in which the content transmitting device 300 of Embodiment 2 transmits, to the content receiving device 305, the “content in association with the transmission-side time information”. Fist, as illustrated in FIG. 6, the characteristic point detecting section 301 judges whether or not there is a characteristic point in a waveform of the inputted AC voltage (S401). When there is a characteristic point, the characteristic point detecting section 301 outputs information (characteristic point information), which is about the detected characteristic point, to the time information generating section 302. Note that the characteristic point may be, for example: (i) a zero-crossing point where the AC voltage is 0V; (ii) a peak point at which the AC voltage is the maximum value; or (iii) noise being mixed into the AC voltage, the noise being attributed to other electric devices (e.g. microwave oven) which share the same AC power supply 201 in the content distribution system 30.

The time information generating section 302 corrects the transmission-side time information based on the inputted characteristic point information (S402). For example, a frequency of a home-use AC voltage of 100V supplied from a electric power supply company is maintained constant. For instance, the frequency in Kanto area (Eastern Japan) is maintained at 50 Hz, where as the frequency is maintained at 60 Hz in Kansai area (Western Japan). In short, the frequency of the AC voltage supplied to houses in Kanto area is 50 Hz, and therefore one cycle of the AC voltage waveform is 20 ms. Thus, where the characteristic point is a zero-crossing point, the characteristic point detecting section 301 detects a zero-crossing point in the inputted AC voltage waveform at a ratio of once every 10 ms (i.e. every half a wavelength of the AC voltage waveform).

For example, it is supposed that the time information generating section 302 receives the characteristic point information of a characteristic point detected at this timing. If the transmission-side time information, which is generated upon reception of a certain piece of the characteristic point information, indicates “2 hrs 36 min. 51.98 sec.”, the transmission-side time information generated upon reception of the next characteristic point information is counted up by 10 ms, so that the latter transmission-side time information indicates “2 hrs. 36 min. 51.99 sec.”. Then, when the time information generating section 302 receives yet another piece of the characteristic point information, the transmission-side time information is counted up by 10 ms, so that the transmission-side time information indicates “2 hrs. 36 min. 52.00 sec.”. Thus, it is possible to accurately generate the transmission-side time information which is counted up in increment of the smallest time unit of 10 ms.

Note that a provision of a local clock allows the time information generating section 302 to generate more highly accurate transmission-side time information. In this case, during an interval between an input and another input of the characteristic point information, the time information generating section 302 may count up the transmission-side time information in increment of a smaller time unit based on the local clock. Note that the local clock itself has drift or jitter. Accordingly, the local clock itself is adjusted based on the inputted characteristic point information, by using a PLL (Phase Locked Loop) circuit, for the purpose of generating more accurate transmission-side time information.

Next, the content processing section 304 judges whether or not there is content to be transmitted to the content receiving device 305 in the content distribution system 30 (S403). Here, if there is content to be transmitted, the content processing section 304 outputs the content to the communicating section 303. The communicating section 303 adds, to the content having been received, the transmission-side time information received from the time information generating section 302 (S404). Then, the communicating section 303 transmits, from the content transmitting device 300, the “content in association with the transmission-side time information” (S405).

Note that the communicating section 303 may process the transmission-side time information received from the time information generating section 302, prior to the addition of the transmission-side time information to the content. For example, the communicating section 303 may: (i) add, to the transmission-side time information, an additional piece of information such as time needed for transmission of content; and then (ii) add, to the content, the transmission-side time information along with the additional information. This allows the content transmitting device 300 to designate time to start processing the content in the content receiving device 305 to which the audiovisual is transmitted. Further, for example, if a device, which receives content, plays video content at a speed which is 1.2 times faster, the content transmitting device 300 may adjust the transmission-side time information for the 1.2 times faster speed, prior to the addition of the transmission-side time information to the content.

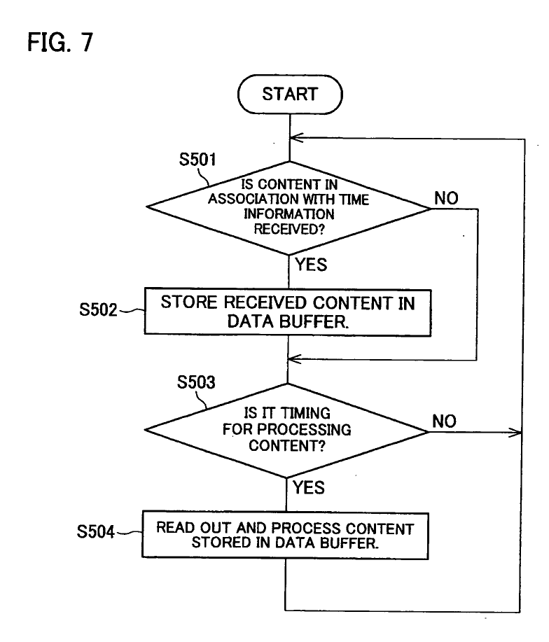

Next described with reference to FIG. 7 is a procedure in which the content receiving device 305 receives and processes the “content in association with the transmission-side time information” received from the content transmitting device 300.

FIG. 7 is a flowchart illustrating a procedure in which (i) the content receiving device 305 of Embodiment 2 receives the “content in association with the transmission-side time information” from the content transmitting device 300 in the content distribution system 30, and (ii) the content receiving device 305 processes the “content in association with the transmission-side time information”.

As illustrated in FIG. 7, the communicating section 308 judges whether or not the “content in association with the transmission-side time information” is received from the content transmitting device 300 (S501). Here, if the “content in association with the transmission-side time information” is received, the communicating section 308 outputs, to the content processing section 309, the “content in association with the transmission-side time information”.

The content processing section 309 temporarily stores, in its data buffer, the “content in association with the transmission-side time information” received from the communicating section 308. Meanwhile, the content processing section 309 calculates the timing for processing the inputted content, based on the transmission-side time information having been added to the content, and stores the calculated timing as a processing timing in the data buffer (S502). Further, from the time information generating section 307, the reception-side time information is inputted to the content processing section 309. Then, the content processing section 309 compares the received reception-side time information with the processing timing stored in the data buffer, so as to judge whether or not it is time for processing the content (S503). If the received reception-side time information matches with the processing timing in the data buffer, the content processing section 309 reads out the content which has been temporarily stored in the data buffer, and processes the content (S504). More specifically, in a case where the content receiving device 305 is a TV set, content is played in accordance with the process timing which is determined by the content transmitting device 300. Further, in a case where the content receiving device 305 is a video deck, the content is recorded on a video tape, according to the timing which has been determined by the content transmitting device 300.

As described, both of the content transmitting device 300 and the content receiving device 305 which share the AC power supply 201 generate, based on the waveform of the common AC voltage supplied from the AC power supply 201, the characteristic point information about the characteristic point in the waveform of the AC voltage. Further, the time information is generated based on the respective pieces of the characteristic point information generated. The content receiving device 305 processes the content in sync with the content transmitting device 300, based on the correlation between (i) the transmission-side time information generated in the content transmitting device 300 and (ii) the reception-side time information generated in the content receiving device 305. The transmission-side time information and the reception-side time information are both generated based on the waveform of the AC voltage. Typically, a characteristic (frequency, amplitude, etc.) of the waveform of the AC voltage supplied from the AC power supply 201 is rigorously and accurately adjusted. Accordingly, it is guaranteed that the characteristic point information generated based on the common AC voltage is generated at the same time interval in both of the content receiving device 305 and the content transmitting device 300. Thus, both of the transmission-side time information and the reception-side time information indicate the same time information (time interval or the like), without fail. Thus, the content receiving device 305 is able to process the received content in sync with the content transmitting device 300, in accordance with the timing corresponding to that at which the content transmitting device 300 processes the content.

Further, in the content distribution system 30, even if the content transmitting device 300 is replaced with another content transmitting device 300 due to a breakdown or the like, the content receiving device 305 generates the time information based on the characteristic point in the AC voltage inputted, and processes the content based on the time information. In short, the content receiving device 305 does not have to acquire, from the other content transmitting device 300 which is newly added to the content distribution system 30, information for processing the content in sync with the other content transmitting device 300. Accordingly, in the content distribution system 30, even if the content transmitting device 300 is replaced with another content transmitting device 300, the content receiving device 305 is able to process the content in sync with the new content transmitting device 300, without a need of process for synchronizing the content receiving device 305 with the content transmitting device 300.

Note that the characteristic point (e.g. zero-crossing point) to be detected may be determined in advance in the content transmitting device 300 and the content receiving device 305. More specifically, the devices in the content distribution system 30 may be set so that all the devices in the system detects the same type of the characteristic point. For example, if the content transmitting device 300 detects a zero-crossing point as a characteristic point, the content receiving device 305 also detects a zero-crossing point as a characteristic point.

Further, the content transmitting device 300 and the content receiving device 305 may be integrally formed. That is, the present invention may be realized in the form of a content processing device which has functions of the content transmitting device 300 and the content receiving device 305.

Further, the content transmitting device 300 may separately transmit, to the content receiving device 305, the transmission-side time information and the content. In this case, the communicating section 303 associates the transmission-side time information with the content, and transmits the transmission-side time information and the content which are associated with each other to the content receiving device 305. For example, the communicating section 303 assigns an identical identifier to the transmission-side time information and the content, and transmits the transmission-side time information and the content, each having the identifier, to the content receiving device 305. The content receiving device 305 confirms the correlation between the transmission-side time information and the content based on the identifiers respectively assigned to both of the transmission-side time information and the content. This allows the content receiving device 305 to process the content associated with the transmission-side time information, based on the correlation between (i) the transmission-side time information and (ii) the reception-side time information which is under the control of the content receiving device 305.

### EMBODIMENT 3

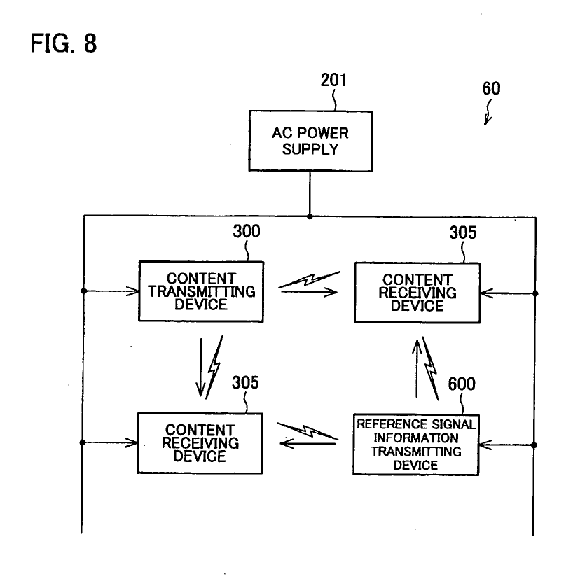

The following describes, with reference to FIG. 8 to FIG. 10, Embodiment 3 of the present invention.

First described with reference to FIG. 8 is an overview of a content distribution system 60 of Embodiment 3 in accordance with the present invention. FIG. 8 is a block diagram illustrating a configuration of the content distribution system 60 of Embodiment 3. As illustrated in the figure, the content distribution system 60 includes: an AC power supply 201; a content transmitting device 300; two content receiving devices 305; and a reference signal information transmitting device 600. To each of the devices in the content distribution system 60, a common AC voltage is supplied from the same AC power supply 201. Based on this AC voltage, each of the devices processes content, in sync with one anther.

In particular, in the content distribution system 60, the reference signal information transmitting device 600 generates reference signal information and transmits the reference signal information to the content receiving devices 305. Based on the received reference signal information, the content receiving devices 305 correct their respective pieces of reception-side time information, each of which pieces being under the control of the respective content receiving devices 305. This allows the plurality of the content receiving devices 305 to process the content, in exact sync with each other.

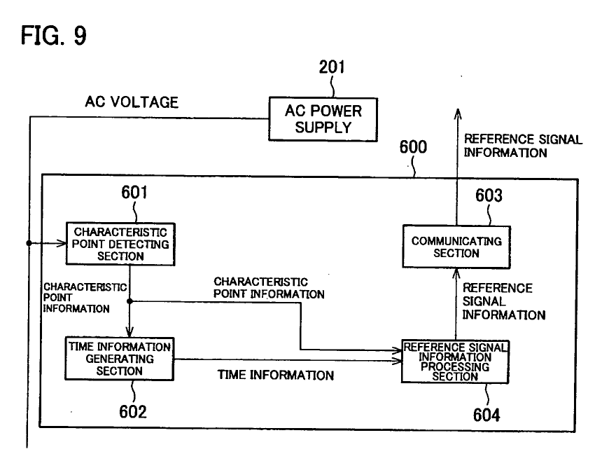

The following describes, with reference to FIG. 9, the reference signal information transmitting device 600 of Embodiment 3 in accordance with the present invention.

FIG. 9 is a block diagram illustrating an exemplary configuration of the reference signal information transmitting device 600. As illustrated in the figure, the reference signal information transmitting device 600 includes: a characteristic point detecting section 601; a time information generating section 602; a communicating section 603; and a reference signal processing section 604.

The characteristic point detecting section 601 observes the waveform of the AC voltage supplied to the reference signal information transmitting device 600, so as to detect a characteristic point. Further, the characteristic point detecting section 601 outputs information regarding the detected characteristic point to the time information generating section 602 and the reference signal information processing section 604.

The time information generating section 602 generates time information based on the characteristic point information inputted from the characteristic point detecting section 601, and outputs the generated time information to the reference signal information processing section 604.

The communicating section 603 transmits, to the other devices in the content distribution system 60, the reference signal information received from the reference signal information processing section 604. Further, the communicating section 603 receives reference signal information transmitted from the other device in the content distribution system 60, and outputs the reference signal information to the reference signal information processing section 604.

Note that the reference signal information is information used for synchronizing the processing of content amongst devices in the content distribution system 60. This reference signal information is transmitted to an unspecified receiving-end in the content distribution system 60. This allows the reference signal information to be commonly used in each of the devices receiving the reference signal information. Based on the reference signal information, each of the devices in the content distribution system 60 processes the content in sync with one another. For example, the devices are able to correct, based on the reference signal information, the respective pieces of the time information which are under the control of the respective devices. Such reference signal information may be, for example, a control signal such as beacon, or a data frame or a control frame including time information.

The reference signal information processing section 604 generates the reference signal information to be transmitted to the other devices in the content distribution system 60, based on, for example, the characteristic point information inputted from the characteristic point detecting section 601 or the time information inputted from the time information generating section 602, and outputs the reference signal information to the communicating section 603.

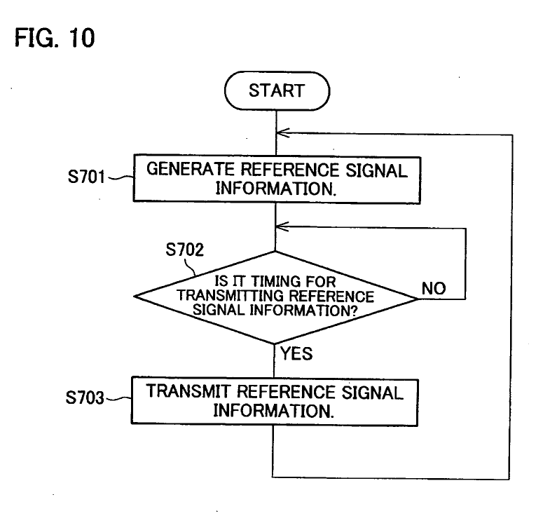

The following describes, with reference to FIG. 10, a procedure in which the reference signal information transmitting device 600 transmits, as the reference signal information, a control signal such as a beacon.

FIG. 10 is a flowchart illustrating a procedure in which the reference signal information transmitting device 600 of Embodiment 3 transmits, as the reference signal information, the control signal such as a beacon to the other devices in the content distribution system 60.

As illustrated in FIG. 10, the reference signal information processing section 604 first generates the reference signal information to be transmitted to the other devices in the content distribution system 60 (S701). At this point, the reference signal information processing section 604 may include, in the reference signal information, the transmission-side time information which indicates the timing for transmitting the reference signal information. Note that the timing for transmitting the reference signal information is determined based on the specification and technical standard applied to a communication network used in the content distribution system 60. For example, in a case of a communication network in which a beacon cycle is defined as to be 20 ms according to its specification, the timing for transmitting a beacon as the reference signal information is 20 ms after the transmission of the previous beacon.

Next, the reference signal information processing section 604 judges, based on the time information inputted from the time information generating section 602, whether or not it is the timing for transmitting the generated reference signal information (S702). Here, if it is the timing for transmitting the reference signal information, the reference signal information processing section 604 instructs the communication section 603 to transmit the reference signal information. Upon reception of the instruction, the communicating section 603 transmits, to the other devices in the content distribution system 60, the reference signal information received from the reference signal information processing section 604 (S703). Then, the reference signal information processing section 604 prepares for transmission of a next piece of the reference signal information (S701).

Note that, through the series of processes for transmitting the reference signal information, the reference signal information transmitting device 600 may transmit, as the reference signal information, not only the control signal such as a beacon, but also a data frame or a control frame including time information. In this case, the timing for transmitting the reference signal information can be freely determined, and the timing may be defined based on the design specification for implementing the content distribution system 60 or the reference signal information transmitting device 600.

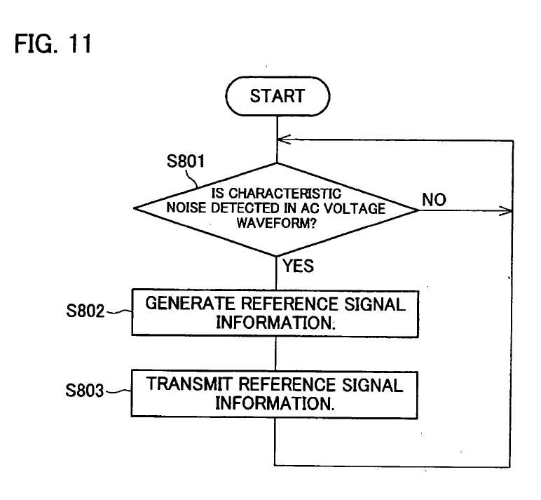

The following describes, with reference to FIG. 11, a procedure in which the reference signal information transmitting device 600 transmits data frame or a control frame as the reference signal information.

FIG. 11 is a flowchart illustrating a procedure in which the reference signal information transmitting device 600 of Embodiment 3 transmits, to the other devices in the content distribution system 60, the data frame or the control frame as the reference signal information, the data frame or the control frame including time information.

As illustrated in FIG. 11, the characteristic point detecting section 601 judges whether or not a characteristic noise is detected in the waveform of the inputted AC voltage (S801). If the noise is detected, the characteristic point detecting section 601 outputs the information about the noise, as the reference signal information, to the reference signal information processing section 604. The time information generating section 602 generates the transmission-side time information based on the inputted characteristic point information, and outputs the transmission-side time information to the reference signal information processing section 604. Based on the transmission-side time information received from the time information generating section 602, the reference signal information processing section 604 generates the reference signal information which includes (i) the transmission-side time information indicating the time at which the noise has been detected, and (ii) the characteristic point information having been inputted (S802). Then, the reference signal information processing section 603 outputs, to the communicating section 603, the reference signal information generated. Then, the communicating section 603 transmits, to the other devices in the content distribution system 60, the reference signal information (S803).

In general, noise is defined as a spontaneous thing which possesses no value. However, in the present invention, the noise in the waveform of the AC voltage has a broader meaning that a thing which does not fall under the ideal form of the AC voltage waveform. Accordingly, in addition to spontaneous noise, the meaning of “noise” in the present invention includes noise which is intentionally generated for the purpose of synchronizing the devices in the content distribution system 60. Further, a carrier wave, which is used in a data transmission technology adopting a power line using a power transmission technology, is also regarded as a noise which is superimposed on an idealistic AC voltage waveform.

Note that the each content receiving device 305 (i) receives the reference signal information transmitted from the reference signal information transmitting device 600, and (ii) corrects the reception-side time information based on the reference signal information received, through a process which is identical to that carried out in the content receiving device 202 described in the foregoing Embodiment 1. Therefore, the explanation for the process is omitted here.

As described, in the content distribution system 60, the plurality of the content receiving device 305 receive the reference signal information transmitted from the reference signal information transmitting device 600, and correct their respective pieces of the reception-side time information based on the reference signal information. Thus, the respective pieces of the reception-side time information in the plurality of the content receiving devices 305, each piece used as a reference time in processing the content, have exactly the same progression. That is, the frequency and the phase of the reception-side time information completely match with those of other pieces of the reception-side time information. Since each of the content receiving devices 305 processes the content based on the corrected reception-side time information, the content receiving devices 305 are able to process the content in exact sync with one another, based on the corrected reception-side time information.

Further, even if the content transmitting device 300 is replaced with another content transmitting device 300, the respective pieces of the reception-side time information in the content receiving devices 305, in which the respective pieces of the reception-side information is corrected based on the reference signal information, have identical progressions (i.e., the identical phases and frequencies). Accordingly, there is no need for carrying out a process for synchronizing the plurality of the content receiving devices 305 with the new content transmitting device 300, and yet it is possible to synchronizing the processing of the received content.

Note that the content distribution system 60 may include a plurality of the reference signal information transmitting devices 600. In this case, the reference signal information may be transmitted from one reference signal information transmitting device 600 to another reference signal information transmitting device 600 in the content distribution system 60. In short, the plurality of the reference signal information transmitting devices 600 may exchange the reference signal information with one another.

Further, reference signal information transmitting device 600 may transmit the reference signal information to the content transmitting device 300. In this case, the content transmitting device 300 may correct, based on the reference signal information received, the transmission-side time information to be added to the content to be transmitted.

### EMBODIMENT 4

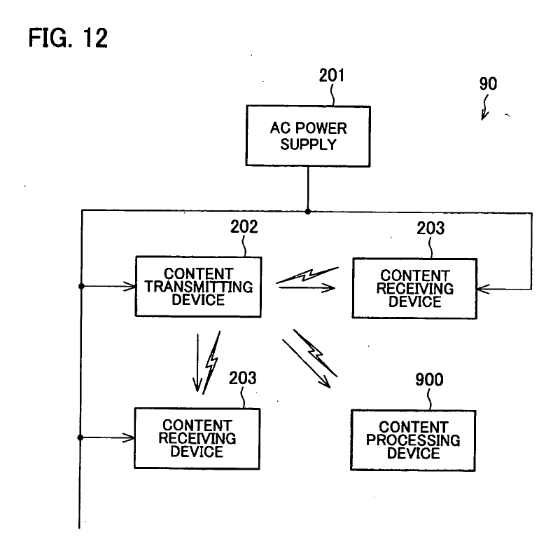

The following describes, with reference to FIG. 12 to FIG. 14, Embodiment 4 of the present invention.

First described with reference to FIG. 12 is an overview of a content distribution system 90 of Embodiment 4 in accordance with the present invention. FIG. 12 is a block diagram illustrating a configuration of the content distribution system 90. As illustrated in the figure, the content distribution system 90 includes: an AC power supply 201; a content transmitting device 202; two content receiving devices 203; and a content processing device 900. From the AC power supply 201, a common AC voltage is supplied to the content transmitting device 202 and the content receiving devices 203. Based on the AC voltage, the content transmitting device 202 and the content receiving devices 203 process content in sync with each other. On the other hand, the AC voltage from the AC power supply 201 is not supplied to the content processing device 900. Instead, the content processing device 900 corrects reception-side time information, which is under the control of the content processing device 900, based on reference signal information received from the content transmitting device 202, thereby processing the content in sync with the content transmitting device 202. Thus, the content processing device 900 is able to process the content in sync with another device in the content distribution system 90, without a need for sharing, with the other device, the same AC power supply 201.

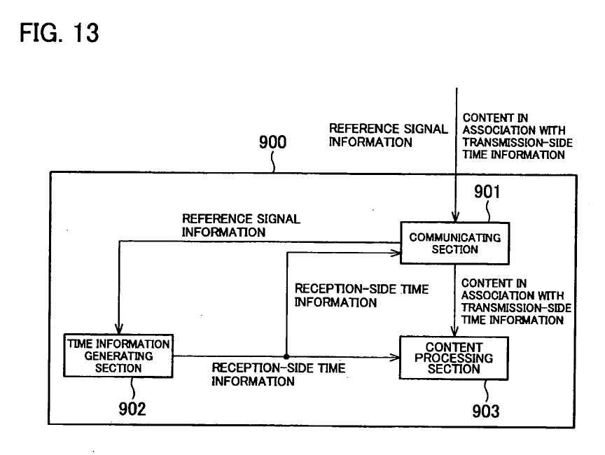

The following describes, with reference to FIG. 13, the detail of the content processing device 900 of Embodiment 4 in accordance with the present invention.

FIG. 13 is a block diagram illustrating an exemplary configuration of the content processing device 900 of Embodiment 4. As illustrated in the figure, the content processing device 900 includes: a communicating section 901; a time information generating section 902; and a content processing section 903. Note that FIG. 13 only illustrates how data flows in the content processing device 900, when the content processing device 900 receives the “content in association with the transmission-side time information” and the reference signal information, each piece of information being transmitted from the content transmitting device 202 in the content distribution system 90.

The communicating section 901 adds transmission-side time information inputted from the time information generating section 902 to content to be transmitted to the other devices in the content distribution system 90, the content being inputted from the content processing section 903. Further, the communicating section 901 transmits, to the other devices in the content distribution system 90, the “content in association with the transmission-side time information”. Further, the communicating section 901 receives the “content in association with the transmission-side time information” from the content transmitting device 202 in the content distribution system 90, and outputs the “content in association with the transmission-side time information” to the content processing section 903. Further, the communicating section 901 receives the reference signal information transmitted from the content transmitting device 202 in the content distribution system 90, and outputs the reference signal information to the time information generating section 902. This reference signal information is generated based on time information which is generated in the content transmitting device 202, based on a characteristic point in the waveform of the AC voltage inputted from the AC power supply 201.

The time information generating section 902 generates reception-side time information based on the reference signal information received from the communicating section 901. Further, the time information generating section 902 outputs the generated reception-side time information to the communicating section 901 and the content processing section 903.

The content processing section 903 outputs, to the communicating section 901, the content which is to be transmitted to the other devices in the content distribution system 90. Further, the content processing section 903 processes the content in the “content in association with the transmission-side time information” which is received from the content transmitting device 202 via the communicating section 901, based on the correlation between (i) the transmission-side time information having been added to the content, and (ii) the reception-side time information inputted from the time information generating section 902.

In the present embodiment, the content processing device 900 does not have to share the AC power supply 201 with the other devices in the content processing system 90. Further, the content processing device 900 does not have to use an AC power supply. In other words, FIG. 12 is an example where the content distribution system 90 includes (i) the content processing device 900 which does not share the AC power supply 201, or (ii) the content processing device 900 which does not use an AC power supply, the content distribution system 90 including the content transmitting device 202 and the content receiving devices 203 which share the AC power supply 201 with each other.

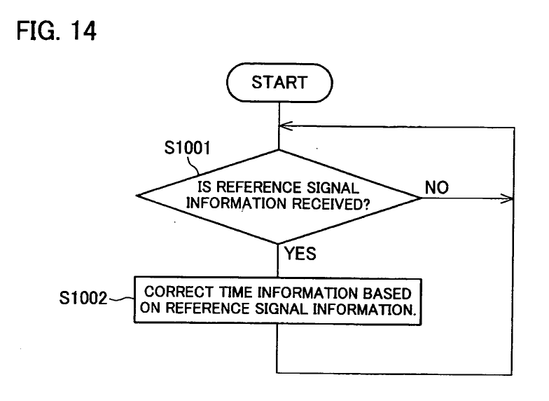

The following describes, with reference to FIG. 14, a procedure of correcting the reception-side time information which is under the control of the content processing device 900, based on the reference signal information having been received.

FIG. 14 is a flowchart illustrating a procedure in which (i) the content processing device 900 of Embodiment 4 receives the reference signal information transmitted from the content transmitting device 202 in the content distribution system 90, and (ii) the content processing device 900 corrects, based on the received reference signal information, the reception-side time information which is under the control of the content processing device 900.

As illustrated in FIG. 14, the communicating section 901 first judges whether or not the reference signal information is received from the content transmitting device 202 (S100). If the reference signal information from the content transmitting device 202 is received, the communicating section 901 outputs the received reference signal information to the time information generating section 902. The time information generating section 902 corrects, based on the received reference signal information, the reception-side time information which is under the control of the time information generating section 902 (S1002). For example, in a case where the time information generating section 902 receives the reference signal information which is a beacon of 20 ms in cycle, the time information generating section 902 counts up the reception-side time information in increment of 20 ms, every time the time information generating section 902 receives the beacon.

Note that, in a case where (i) the time information generating section 902 includes a local clock, and (ii) the reception-side time information is counted up by the local clock, the reception-side time information may be corrected so that the time of the reception-side time information elapses (increases) by 20 ms every time the beacon is received, for the purpose of solving an error, in the local clock, caused by a lot-to-lot difference. Further, such an error in the local clock may be solved by using a smoothing circuit such as PLL (Phase Locked Loop) for correcting the progression (progression speed) of the local clock itself.

A procedure, in which the content processing device 900 of Embodiment 4 processes the “content in association with the transmission-side time information”, is the same as the process carried out by the foregoing content receiving device 305 of Embodiment 2. Therefor, the explanation for the process is omitted here.

### EMBODIMENT 5

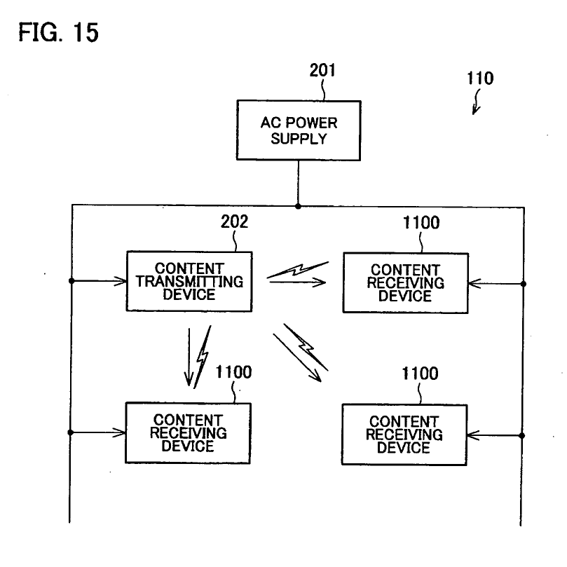

The following describes, with reference to FIG. 15 to FIG. 17, Embodiment 5 of the present invention.

First described with reference to FIG. 15 is an overview of a content distribution system 110 of Embodiment 5 in accordance with the present invention.

FIG. 15 is a block diagram illustrating a configuration of the content distribution system 110. As illustrated in the figure, the content distribution system 110 includes: an AC power supply 201; a content transmitting device 202; and three content receiving devices 1100. From the AC power supply 201, a common AC voltage is supplied to the content transmitting device 202 and each of the content receiving devices 1100. Based on the AC voltage, the content transmitting device 202 and each of the content receiving devices 1100 process content in sync with each other. Further, the content transmitting device 202 transmits reference signal information, and the content receiving devices 1100 receive the reference signal information. Then, the content receiving devices 1100 correct, based on the reference signal information received, the respective pieces of the reception-side time information which are under the control of the respective content receiving devices 1100. Accordingly, the content receiving devices 1100 are able to process the content in sync with the content transmitting device 202.

Note that the each content receiving device 1100 is a device which (i) receives the content, and (ii) transmits, to the other devices in the content distribution system 110, content processed in the content receiving device 1100.

Note that FIG. 15 only illustrates how data flows in the content receiving device 1100, when the content receiving device 1100 receives (i) the “content in association with the transmission-side time information” and (ii) the reference signal information, each of which being transmitted from the content transmitting device 202 in the content distribution system 110.

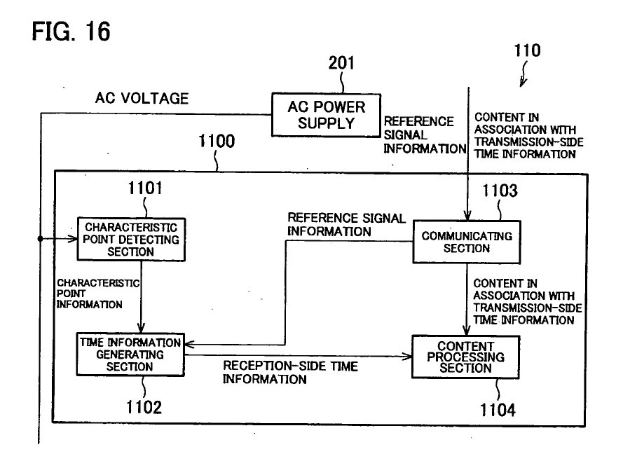

The following describes in detail, with reference to FIG. 16, the content receiving device 1100 of embodiment 5 in accordance with the present invention.

FIG. 16 is a block diagram illustrating an exemplary configuration of the content receiving device 1100. As illustrated in the figure, the content receiving device 1100 includes: a characteristic point detecting section 1101; a time information generating section 1102; a communicating section 1103; and a content processing section 1104.

The characteristic point detecting section 1101 detects a characteristic point in the waveform of the AC voltage supplied to the content receiving device 1100. Then, characteristic point detecting section 1101 outputs information about the detected characteristic point to the time information generating section 1102.

The time information generating section 1102 generates the reception-side time information based on the characteristic point information received from the characteristic point detecting section 1101. Further, the time information generating section 1102 outputs the generated reception-side time information, to the communicating section 1103 and the content processing section 1104. Further, the characteristic point information which is inputted from the characteristic point detecting section 1101 is stored in a data buffer (not shown), along with the reception-side time information which indicates the time of detecting the characteristic point. Further, when the reference signal information is received from the communicating section 1103, the time information generating section 1102 compares (i) the characteristic point information and the transmission-side time information in the reference signal information with (ii) the characteristic point information and the reception side time information which are stored in the time information generating section 1102. In this way, the time information generating section 1102 corrects the reception-side time information which is under the control of the time information generating section 1102.

The communicating section 1103 adds the transmission-side time information inputted from the time information generating section 1102, to the content which is (i) inputted from the content processing section 1104, and (ii) to be transmitted to the other devices in the content distribution system 110. Further, the communicating section 1103 transmits, to the other devices in the content distribution system 110, the “content in association with the transmission-side time information”. Further, the communicating section 1103 receives the “content in association with the transmission-side time information” from the content transmitting device 202 in the content distribution system 110, and outputs the “content in association with the transmission-side time information” to the content processing section 1104.

The content processing section 1104 outputs, to the communicating section 1103, the content to be transmitted to the other devices in the content distribution system 110. Further, the content processing section 1104 receives the “content in association with the transmission-side time information” which is received by the communicating section 1103 from the content transmitting device 202 in the content distribution system 110. Then, the content processing section 1104 processes the content received, based on the correlation between (i) the transmission-side time information having been added to the received “content in association with the transmission-side time information”; and (ii) the reception-side time information received from the time information generating section 1102.

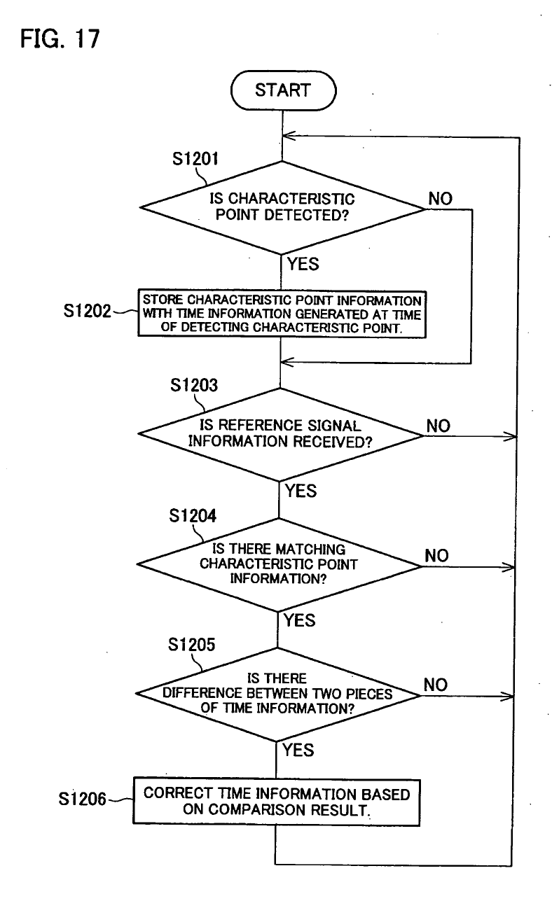

The following describes, with reference to FIG. 17, a procedure for correcting, based on the reference signal information having been received, the reception-side time information which is under the control of the content receiving device 1100.

FIG. 17 is a flowchart illustrating a procedure in which (i) the content receiving device 1100 of Embodiment 5 receives the reference signal information from the content transmitting device 202 in the content distribution system 110, and (ii) the content receiving device 1100 corrects, based on the received reference signal information, the reception-side time information which is under the control of the content receiving device 1100.

Fist, as illustrated in FIG. 17, the characteristic point detecting section 1101 judges whether or not a characteristic point is detected in a waveform of the AC voltage (S1201).

If no characteristic point is detected, the process goes to S1203.

When there is a characteristic point, the characteristic point detecting section 1101 outputs information about the characteristic point detected, to the time information generating section 1102. The time information generating section 1102 stores, in the data buffer (not shown), the characteristic point information which is inputted from the characteristic point detecting section 1101, along with the reception-side time information which indicates the time at which the characteristic point is detected (S1202).

Next, the communicating section 1103 judges whether or not the reference signal information is received (S1203).

If the reference signal information is not received, then the process returns to S1201.

If the reference signal information is received, the communicating section 1103 outputs, to the time information generating section 1102, the reference signal information received.

Next, the time information generating section 1102 compares (i) the characteristic point information in the reference signal information received from the communicating section 1103 with (ii) characteristic point information stored in the time information generating section 1102, so as to judge whether or not the characteristic point information in the reference signal information match with any pieces of the characteristic point information stored in the time information generating section 1102 (S1204).

If there is no matching characteristic point information, the process returns to S1201.

If there is a matching piece of the characteristic point information, the time information generating section 1102 compares (i).the transmission-side time information which indicates the time at which the content transmitting device 202 detected the characteristic point, the content transmitting device 202 having transmitted the reference signal information, with (ii) the reception-side time information which is stored in the time information generating section 1102, so as to judge if there is a difference between these pieces of time information (S1205).

If there is no difference between these pieces of time information, the process returns to S1201.

If there is a difference between these pieces of time information, the time information generating section 1102 corrects the reception-side time information which is under the control of the time information generating section 1102 so that the difference becomes zero (S1206). After the correction of the reception-side time information, the process returns to S1201.

For example, the time information generating section 1102 may correct the reception-side time information as follows. Namely, the time information generating section 1102 may overwrite the reception-side time information, which is under the control of the time information generating section 1102, with the transmission-side time information indicating the time at which the content transmitting device 202 detected the transmission-side characteristic point, the transmission-side time information being included in the reference signal information received.

Further, instead of overwriting the reception-side time information all at once, the time information generating section 1102 may count up or count down the time indicated by the reception-side time information so that the difference between the transmission-side time information and the reception-side time information gradually disappears with the elapse of time.

Alternatively, the difference between the transmission-side time information and the reception-side time information may be gradually eliminated, by adjusting the local clock (e.g. increasing or decreasing the speed of the local clock) provided in the time information generating section 1102.

A procedure in which the content receiving device 1100 of Embodiment 5 processes the “content in association with the transmission-side time information” is the same as the process carried out by the foregoing content receiving device 305 of Embodiment 2. Therefore, the explanation for the process is omitted here.

### EMBODIMENT 6

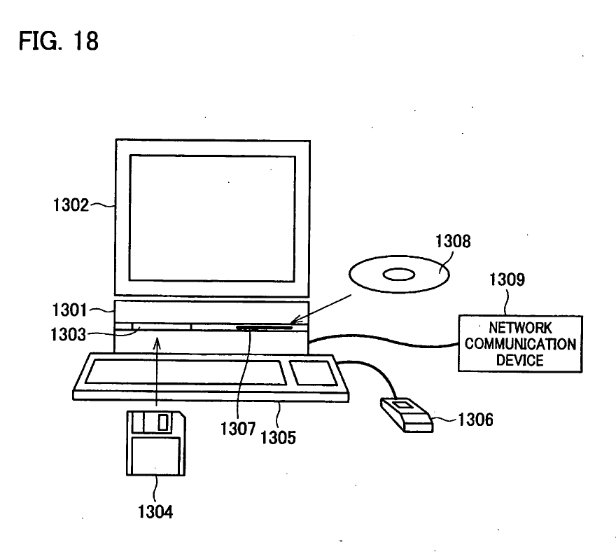

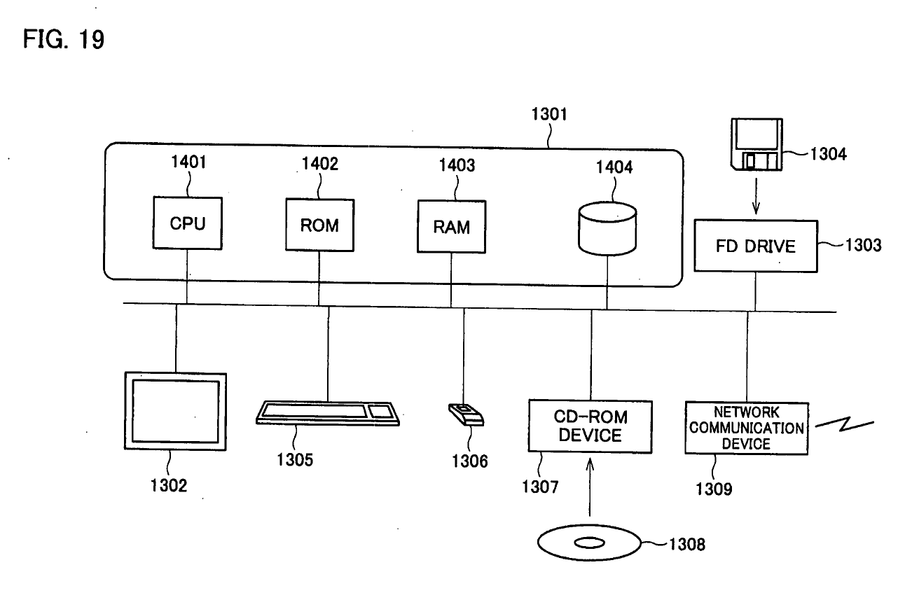

The following describes, with reference to FIG. 18 and FIG. 19, Embodiment 6 of the present invention.

FIG. 18 is a diagram illustrating exemplary exterior appearances of the devices of Embodiments 1 through 5, in accordance with the present invention. In the figure, illustrated are: a computer main body 1301; a display device 1302; an FD drive 1303 into which FD (Flexible Disk) 1304 may be inserted; a keyboard 1305; a mouse 1306; a CD-ROM device 1307 to which a CD-ROM (Compact Disc-Read Only Memory) 1308 may be inserted; and a network communication device 1309.

A synchronization program which realizes the functions of the devices is supplied, to the computer main body 1301, from a computer-readable recording medium such as the FD 1304 or a CD-ROM 1308. By running this synchronization program on the computer main body 1301, the synchronized processing of the content and/or the correction of the time information described in the foregoing embodiments are carried out.

Note that the explanation for the synchronized processing of the content is omitted here, as it is similar to the process carried out by the devices of Embodiments 1 through 5, in accordance with the present invention. Further, the synchronization program may be distributed, to the computer main body 1301, from another computer via a communication line and the network communication device 1309.

Further, a recording medium for storing the synchronization program is not limited to the FD 1304 or the CD-ROM 1308. For example, the Recording medium may be: electromagnetic tape; an MO (Magnetic Optical disk); an MD (Mini Disc); a DVD (Digital Versatile Disc); an IC (Integrated Circuit) card, or the like.

FIG. 19 is a block diagram illustrating an exemplary configuration of each of the devices of Embodiments 1 through 5, in accordance with the present invention. A computer main body 1301 illustrated in FIG. 19 includes: a CPU (Central Processing Unit) 1401; a ROM (Read Only Memory) 1402; a RAM (Random Access Memory) 1403; and a hard disk 1404.

The CPU 1401 processes data, while outputting/receiving data to/from: the display device 1302; the FD drive 1303; the keyboard 1305; the mouse 1306; the CD-ROM device 1307; the network communication device 1309; the ROM 1402; the RAM 1403; or the hard disk 1404.

The CPU 1401 installs, in the hard disk 1404, the synchronization program, which is stored in the FD 1304 or the CD-ROM 1308, via the FD drive 1303 or the CD-ROM device 1307. Then, the CPU 1401 loads onto the RAM 1403 the synchronization program from the hard disk 1404 as needed, and run the program for carrying out the foregoing synchronized processing of content.

Note that the explanation for the synchronized processing of content is omitted here, as it is similar to the process carried out by the devices of Embodiments 1 through 5.

The embodiments and concrete examples of implementation discussed in the foregoing detailed explanation serve solely to illustrate the technical details of the present invention, which should not be narrowly interpreted within the limits of such embodiments and concrete examples For example, in each of the foregoing embodiments, content is transmitted from a content transmitting device to a content receiving device, via a wireless or wired communication path. However, in the content distribution system of the present invention, the content transmitting device may provide the content by recording the content on a recording medium such as a DVD, and the content receiving device may read out and process the content provided via the recording medium on which the content has been recorded.

Further, the technical scope of the present invention is defined by claims set forth hereinbelow, and not defined by the description of the foregoing embodiments. In other words, any variation within the scope of the claims, and any feature which is equivalent to a feature set forth in the claims shall fall within the technical scope of the present invention.

For example, the foregoing embodiments deal with the case where a characteristic point detecting section detects a characteristic point in a waveform of an AC voltage supplied from an AC power supply. However, the characteristic point detecting section is not limited to this, provided that the characteristic point detecting section detects a characteristic point existing in a wave form of the AC power supply. In this sense, the characteristic point detecting section may be a characteristic point detecting section which detects a characteristic point in a waveform of a current inputted from the AC power supply. Further, the characteristic point detecting section is not limited to such a characteristic point detecting section.

Further, in order to prevent deterioration in a quality of content being streamed from another device, a device of the present invention is a device which is capable of ensuring time consistency between a plurality of devices handling the content, the device including: (A) means for detecting a characteristic point in a waveform of an AC power supply; (B) means for generating own time information based on the characteristic point having been detected; (C) means for transmitting, to the another device, given content and the own time information, the content and the own time information being transmitted in association with each other; and (D) means for carrying out, when content which is in association with time information of the another device is received from the another device sharing the same power supply, at least one of (i) a reproduction, (ii) a recording process, and (iii) an editing process with respect to the content received, based on a correlation between (a) the time information generated in the device, and (b) the time information which is received, along with the content, from the another device.

Further, it is preferable that the device of the present invention further include means for (i) generating, based on the own time information, reference signal information for ensuring the time consistency between the plurality of the devices, and (ii) transmitting the reference signal information to the other device sharing the AC power supply.

Further, in order to prevent deterioration in a quality of content being streamed from another device, a device of the present invention may be a device which is capable of ensuring time consistency between a plurality of devices handling the content, the device including: (A) means for receiving reference signal information from another device; (B) means for generating own time information, based on the reference signal information having been received; (C) means for transmitting, to yet another device, content and the own time information generated by time information generating means, the content and the own time information being transmitted in association with each other; and (D) means for carrying out, when content in association with time information of the yet another device is received from the yet other device, at least one of (i) a reproduction, (ii) a recording process, and (iii) an editing process with respect to the received content, based on a correlation between (a) the own time information generated in the device, and (b) the time information of the yet another device, which is received from the yet another device, along with the content, wherein the another device carries out (a) a process of detecting a characteristic point in a waveform of an AC power supply, and generating characteristic point information about the detected characteristic point, (b) a process of generating, based on the characteristic point information, time information of the another device's own, and (c) a process of generating, based on the time information of the another device's own, the reference signal information which is for ensuring the time consistency.

Further, the device of the present invention may be so adapted that the characteristic point in the waveform of the AC power supply is a zero-crossing point of the waveform.

Further, the device of the present invention may be so adapted that the characteristic point in the waveform of the AC power supply is a peak of the waveform.

Further, the device of the present invention may be so adapted that the characteristic point in the waveform of the AC power supply is a characteristic noise superimposed on the waveform.

Further, in order to prevent deterioration in a quality of content being streamed from another device, a program of the present invention is a program which ensures time consistency between a plurality of devices handling the content, the program causing a computer to carry out the steps of: (A) detecting a characteristic point in a waveform of an AC power supply; (B) generating own time information based on the characteristic point having been detected; (C) transmitting, to the other device having the similar configuration, the own time information and the content, each of which being transmitted in association with each other; and (D) carrying out, when content which is in association with time information of the another device's is received from the another device sharing the same power supply, at least one of (i) a reproduction, (ii) a recording process, and (iii) an editing process with respect to the content received, based on a correlation between (a) the own time information generated in the device, and (b) the time information of the another device, which is received from the other device, along with the content.

Further, it is preferable that the program of the present invention further includes the step of (E) generating reference signal information which is for ensuring the time consistency between the plurality of the device, and transmitting the reference signal information, to the other device sharing the AC power supply.

Further, in order to prevent deterioration in a quality of content being streamed from another device, a program of the present invention is a program which ensures time consistency between a plurality of devices handling the content, the program causing a computer to carry out the steps of: (A) receiving reference signal information from another device; (B) generating own time information, based on the reference signal information having been received; (C) transmitting, to yet another device, content and the own time information generated in the step (B), the content and the own time information being transmitted in association with each other; and (D) carrying out, when content in association with time information of the yet another device is received from the yet another device, at least one of (i) a reproduction, (ii) a recording process, and (iii) an editing process with respect to the received content, based on a correlation between (a) the own time information generated in the device, and (b) the time information of the yet another device, which is received from the yet another device, along with the content, wherein the another device carries out (a) a process of detecting a characteristic point in a waveform of an AC power supply, and generating characteristic point information about the detected characteristic point, (b) a process of generating, based on the characteristic point information, time information of the another device's own, and (c) a process of generating, based on the time information of the another device's own, the reference signal information which is for ensuring the time consistency.

Further, a recording medium of the present invention is a computer readable recording medium which stores therein at least one of the foregoing programs for causing a computer to function.

With the present invention, it is possible to prevent quality deterioration, which is caused by a variation amongst different source devices, in a transmission of content. Thus, it is possible to provide a service of transmitting high-quality content. Further, the present invention also allows a plurality of devices to easily share common time information. This allows, for example, the plurality of the devices to reproduce content at the same time. For example, even if audio content is separately transmitted to speakers of a 5.1-channel surround sound system, the speakers are able to reproduce the audio content without any one of them being out of sync with the other speakers.

It is preferable that a content processing device of the present invention include: reference signal information generating means for generating, based on own time information, reference signal information for correcting time information of another content processing device; and a reference signal information transmitting means for transmitting the reference signal information to the another content processing device.

With the configuration, the reference signal information generated in a content processing device is transmitted to another content processing device. At this point, the reference signal information to be transmitted to the content processing device to the other content processing device is generated based on the own time information, and for correcting the time information of the other content processing device. Accordingly, content processing devices receiving the reference signal information correct, based on the reference signal information received, their respective pieces of time information which are under the control of the respective content processing devices. Thus, the respective pieces of the time information in the content processing devices match with one another. In short, the content processing devices are able to synchronize, with one another, the processing of the content received.

Further, each of the content processing device, which has corrected its time information based on the reference signal information, keeps processing the content based on information about the characteristic point in the waveform of the common AC power supply. Thus, once the content processing devices are completely synchronized with one another, the content processing devices process the content based on their respective pieces of time information which are generated at an identical timing. Accordingly, even if the content processing device transmitting the content is switched to another content processing device, the content processing devices receiving the content are able to keep processing the content in sync with one another, without a need of receiving new reference signal information from the new content processing device.

Note that, in the content processing device of the present invention, it is preferable that the means for processing the content carry out, with respect to the content received, at least one of a reproduction, a recording process, and an editing process. Further, the characteristic point in the waveform of the AC power supply is preferably (i) a zero-crossing point of the waveform (a point at which a value of an AC voltage from the AC power supply becomes 0); (ii) a peak of the waveform (a point at which the value of the AC voltage from the AC power supply is the maximum); or (iii) a characteristic noise superimposed on the waveform.

Further, a content distribution system of the present invention includes the foregoing content transmitting device and the foregoing audiovisual receiving device. Thus, it is possible to provide a content distribution system in which, even if the content transmitting device is replaced with another content transmitting device, the content receiving device is able to keep processing the content in sync with the other content transmitting device, without a need of carrying out a process for synchronizing the content receiving device with the new content transmitting device.

Note that the content processing device may be realized on a computer. Therefore, the scope of the present invention includes: a content processing-synchronizing program which realizes, on a computer, the content processing device by causing the computer to function as each means of the content processing device; and a computer-readable recording medium storing therein the content processing-synchronizing program.

Further, it is also possible to realize the content transmitting device on a computer. Therefore, the scope of the present invention includes: a content processing-synchronizing program which realizes, on a computer, the content transmitting device by causing the computer to function as each means of the content transmitting device; and a computer-readable recording medium storing therein the content processing-synchronizing program.

Further, it is also possible to realize the content receiving device on a computer. Therefore, the scope of the present invention includes: a content processing-synchronizing program which realizes, on a computer, the content receiving device by causing the computer to function as each means of the content receiving device; and a computer-readable recording medium storing therein the content processing-synchronizing program.

The embodiments and concrete examples of implementation discussed in the foregoing detailed explanation serve solely to illustrate the technical details of the present invention, which should not be narrowly interpreted within the limits of such embodiments and concrete examples, but rather may be applied in many variations within the spirit of the present invention, provided such variations do not exceed the scope of the patent claims set forth below.

What is claimed is:

1. A content processing device for performing content process, the content processing device sharing an AC power supply with another device,
comprising:
characteristic point detecting means for (i) detecting a characteristic point in a waveform of the AC power supply, and (ii) generating characteristic point information which is information about the characteristic point detected;
time information generating means for generating, based on the characteristic point information, own time information of the content processing device, the own time information being to be referred in the content process of the content processing device's own or in content process of the another device;
transmitting means for transmitting, to the another device, given content and the own time information generated by time information generating means, the content and the own time information being transmitted in association with each other;
receiving means for receiving, from the another device with which the content processing device shares the AC power supply, given content and time information of the another device, the content and the time information of the another device being in association with each other; and
content processing means for processing the received content, based on a correlation between (i) the time information, which is in association with the received content, of the another device, and (ii) the own time information which is generated by the time information generating means.

2. The content processing device as set forth in claim 1, further comprising:
reference signal information generating means for generating, based on the time information of the another device, reference signal information for use in correcting the time information of the content processing device's own; and
reference signal information transmitting means for transmitting the reference signal information to the another device.

3. A content processing device, comprising:
reference signal information receiving means for receiving reference signal information from a reference signal information transmitting device;
time information generating means for generating own time information based on the reference signal information having been received;
transmitting means for transmitting, to another content processing device, content and the own time information generated by time information generating means, the content and the time information being transmitted in association with each other;
content receiving means for receiving, from the another content processing device, content and time information of the another content processing device, the content and the time information of the another content processing device being in association with each other; and
content processing means for processing the content received from the another content processing device, based on a correlation between (i) the time information, which is associated with the received content, of the another content processing device and (ii) the own time information generated by the time information generating means,
the reference signal information transmitting device carrying out (a) a process of detecting a characteristic point in a waveform of an AC power supply, and generating characteristic point information about the detected characteristic point, (b) a process of generating time information based on the characteristic point information, and (c) a process of generating, based on the time information generated by the reference signal information transmitting device, the reference signal information which is for use in correcting the own time information.

4. The content processing device, as set forth in claim 1, wherein:
the content process performed by the content processing means is at least one of playing, recording, and editing of the received content.

5. The content processing device, as set forth in claim 3, wherein:
the content process performed by the content processing means is at least one of playing, recording, and editing of the received content.

6. The content processing device, as set forth in claim 1, wherein:
the characteristic point in the waveform of the AC power supply is a zero-crossing point of the waveform.

7. The content processing device, as set forth in claim 3, wherein:
the characteristic point in the waveform of the AC power supply is a zero-crossing point of the waveform.

8. The content processing device, as set forth in claim 1, wherein
the characteristic point in the waveform of the AC power supply is a peak of the waveform.

9. The content processing device, as set forth in claim 3, wherein:
the characteristic point in the waveform of the AC power supply is a peak of the waveform.

10. The content processing device, as set forth in claim 1, wherein
the characteristic point in the waveform of the AC power supply is a characteristic noise superimposed on the waveform.

11. The content processing device, as set forth in claim 3, wherein:
the characteristic point in the waveform of the AC power supply is a characteristic noise superimposed on the waveform.

12. A content synchronization program for causing a computer to function as each means of a content processing device for processing content to be transmitted or content received, the content processing device sharing an AC power supply with another device,
wherein
the content processing device includes:
characteristic point detecting means for (i) detecting a characteristic point in a waveform of the AC power supply, and (ii) generating characteristic point information which is information about the characteristic point detected;
time information generating means for generating, based on the characteristic point information, own time information of the content processing device, the own time information being to be referred in the content process of the content processing device's own or in content process of the another device;
transmitting means for transmitting, to the another device, given content and the own time information generated by time information generating means, the content and the own time information being transmitted in association with each other;
receiving means for receiving, from the another device with which the content processing device shares the AC power supply, given content and time information of the another device, the content and the time information of the another device being in association with each other;
content processing means for processing the received content, based on a correlation between (i) the time information, which is in association with the received content, of the another device, and (ii) the own time information which is generated by the time information generating means.

13. An content synchronization program for causing a computer to function as each means of a content processing device,
wherein
the content processing device includes:
reference signal information receiving means for receiving reference signal information from a reference signal information transmitting device;
time information generating means for generating own time information based on the reference signal information having been received;
transmitting means for transmitting, to another device, content and the own time information generated by time information generating means, the content and the time information being transmitted in association with each other;
content receiving means for receiving, from the another content processing device, content and time information of the another content processing device, the content and the time information of the another content processing device being in association with each other; and
content processing means for processing the content received from the another content processing device, based on a correlation between (i) the time information, which is associated with the received content, of the another content processing device and (ii) the own time information generated by the time information generating means,
the reference signal information transmitting device carrying out (a) a process of detecting a characteristic point in a waveform of an AC power supply, and generating characteristic point information about the detected characteristic point, (b) a process of generating time information based on the characteristic point information, and (c) a process of generating, based on the time information generated by the reference signal information transmitting device, the reference signal information which is for use in correcting the own time information.

14. A content transmitting device for transmitting content to a content receiving device, the content transmitting device sharing an AC power supply with the content receiving device,
comprising:
characteristic point detecting means for (i) detecting a characteristic point in a waveform of the AC power supply, and (ii) generating characteristic point information which is information about the characteristic point detected;
time information generating means for generating, based on the characteristic point information, transmission-side time information which is to be referred in the content process of the content transmitting device's own or in content process of the content receiving device; and
transmitting means for transmitting, to the content receiving device, given content and the transmission-side time information, the content and the transmission-side time information being transmitted in association with each other.

15. A content receiving device for processing content transmitted from a content transmitting device, the content receiving device sharing an AC power supply with the content transmitting device,
comprising:
characteristic point detecting means for (i) detecting a characteristic point in a waveform of the AC power supply, and (ii) generating characteristic point information which is information about the characteristic point detected;
time information generating means for generating, based on the characteristic point information, reception-side time information which is to be referred in the content process of the content receiving device's own;
receiving means for receiving, from the content transmitting device, the content and transmission-side time information, the content and the time information of the another device being in association with each other; and
content processing means for processing the received content, based on a correlation between (i) the transmission-side time information which is in association with the received content and (ii) the reception-side time information generated by the time information generating means.

16. A content distribution system including (A) a content transmitting device for transmitting content to a content receiving device and (B) the content receiving device for receiving the content transmitted from the content transmitting device, the content transmitting device and the content receiving device sharing an AC power supply with each other,
wherein:
the content transmitting device includes:
transmission-side characteristic point detecting means for (i) detecting a characteristic point in a waveform of the AC power supply, and (ii) generating characteristic point information which is information about the characteristic point detected;
transmission-side time information generating means for generating, based on the characteristic point information, transmission-side time information which is to be referred in the content process of the content transmitting device's own or in content process of the content receiving device; and
transmitting means for transmitting, to the content receiving device, given content and the transmission-side time information, the content and the transmission-side time information being transmitted in association with each other; and
the content receiving means includes:
reception-side characteristic point detecting means for (i) detecting the characteristic point in the waveform of the AC power supply, and (ii) generating characteristic point information which is information about the characteristic point detected;
reception-side time information generating means for generating, based on the characteristic point information, reception-side time information which is to be referred in the content process of the content receiving device's own;
receiving means for receiving, from the content transmitting device, the content and the transmission-side time information, the content and the time information of the content transmitting device being in association with each other; and
content processing means for processing the received content, based on a correlation between (i) the transmission-side time information which is in association with the received content and (ii) the reception-side time information generated by the reception-side time information generating means.

17. A content synchronization program which causes a computer to function as each means of a content transmitting device for transmitting content to a content receiving device, the content transmitting device sharing an AC power supply with the content receiving device,
wherein
the content transmitting device includes:
characteristic point detecting means for (i) detecting a characteristic point in a waveform of the AC power supply, and (ii) generating characteristic point information which is information about the characteristic point detected;
time information generating means for generating, based on the characteristic point information, transmission-side time information which is to be referred in the content process of the content transmitting device's own or in content process of the content receiving device; and
transmitting means for transmitting, to the content receiving device, given content and the transmission-side time information, the content and the transmission-side time information being transmitted in association with each other.

18. A content synchronization program which causes a computer to function as each means of a content receiving device for processing content transmitted from a content transmitting device, the content receiving device sharing an AC power supply with the content transmitting device,
wherein
characteristic point detecting means for (i) detecting a characteristic point in a waveform of the AC power supply, and (ii) generating characteristic point information which is information about the characteristic point detected;
time information generating means for generating, based on the characteristic point information, reception-side time information which is to be referred in the content process of the content receiving device's own;
receiving means for receiving, from the content transmitting device, the content and transmission-side time information, the content and the time information of the another device being in association with each other; and
content processing means for processing the received content, based on a correlation between (i) the transmission-side time information which is in association with the received content and (ii) the reception-side time information generated by the time information generating means.

19. A recording medium storing a content synchronization program which causes a computer to function as each means of a content processing device for processing content to be transmitted or content received, the content processing device sharing an AC power supply with another device, wherein
the content processing device includes:
characteristic point detecting means for (i) detecting a characteristic point in a waveform of the AC power supply, and (ii) generating characteristic point information which is information about the characteristic point detected;
time information generating means for generating, based on the characteristic point information, own time information of the content processing device, the own time information being to be referred in the content process of the content processing device's own or in content process of the another device;
transmitting means for transmitting, to the another device, given content and the own time information generated by time information generating means, the content and the own time information being transmitted in association with each other;
receiving means for receiving, from the another device with which the content processing device shares the AC power supply, given content and time information of the another device, the content and the time information of the another device being in association with each other; and
content processing means for processing the received content, based on a correlation between (i) the time information, which is in association with the received content, of the another device, and (ii) the own time information which is generated by the time information generating means.

20. A recording medium storing a content synchronization program which causes a computer to function as each means of a content processing device,
wherein
the content processing device includes:
reference signal information receiving means for receiving reference signal information from a reference signal information transmitting device;
time information generating means for generating own time information based on the reference signal information having been received;
transmitting means for transmitting, to another device, content and the own time information generated by time information generating means, the content and the time information being transmitted in association with each other;
content receiving means for receiving, from the another content processing device, content and time information of the another content processing device, the content and the time information of the another content processing device being in association with each other; and
content processing means for processing the content received from the another content processing device, based on a correlation between (i) the time information, which is associated with the received content, of the another content processing device and (ii) the own time information generated by the time information generating means,
the reference signal information transmitting device carrying out (a) a process of detecting a characteristic point in a waveform of an AC power supply, and generating characteristic point information about the detected characteristic point, (b) a process of generating time information based on the characteristic point information, and (c) a process of generating, based on the time information generated by the reference signal information transmitting device, the reference signal information which is for use in correcting the own time information.

21. A recording medium storing a content synchronization program which causes a computer to function as each means of a content transmitting device for transmitting content to a content receiving device, the content transmitting device sharing an AC power supply with the content receiving device,
wherein
the content transmitting device includes:
characteristic point detecting means for (i) detecting a characteristic point in a waveform of the AC power supply, and (ii) generating characteristic point information which is information about the characteristic point detected;
time information generating means for generating, based on the characteristic point information, transmission-side time-information which is to be referred in the content process of the content transmitting device's own or in content process of the content receiving device; and
transmitting means for transmitting, to the content receiving device, given content and the transmission-side time information, the content and the transmission-side time information being transmitted in association with each other.

22. A recording medium storing a content synchronization program which causes a computer to serve as each means of a content receiving device for processing content transmitted from a content transmitting device, the content receiving device sharing an AC power supply with the content transmitting device,
wherein
characteristic point detecting means for (i) detecting a characteristic point in a waveform of the AC power supply, and (ii) generating characteristic point information which is information about the characteristic point detected;
time information generating means for generating, based on the characteristic point information, reception-side time information which is to be referred in the content process of the content receiving device's own;
receiving means for receiving, from the content transmitting device, the content and transmission-side time information, the content and the time information of the another device being in association with each other; and
content processing means for processing the received content, based on a correlation between (i) the transmission-side time information which is in association with the received content and (ii) the reception-side time information generated by the time information generating means.
